(19) United States
(12) Patent Application Publication
(10) Pub. No.: US 2013/0276046 A1
(43) Pub. Date: Oct. 17, 2013

(54) RECEIVING APPARATUS FOR RECEIVING A PLURALITY OF SIGNALS THROUGH DIFFERENT PATHS AND METHOD FOR PROCESSING SIGNALS THEREOF

(71) Applicants: Electronics and Telecommunications Research Institute, (US); SAMSUNG ELECTRONICS CO., LTD., Suwon-si (KR)

(72) Inventors: Hong-seok PARK, Anyang-si (KR); Kug-jin YUN, Yuseong-gu (KR); Jae-jun LEE, Suwon-si (KR); Jin-young LEE, Seo-gu (KR); Hyun-jeong YIM, Seoul (KR); Yong-seok JANG, Hwaseong-si (KR); Won-sik CHEONG, Yuseong-gu (KR); Yu-sung JOO, Yongin-si (KR); Nam-ho HUR, Yuseong-gu (KR); Sung-oh HWANG, Yongin-si (KR)

(73) Assignees: Electronics and Telecommunications Research Institute, Daejeon (KR); Samsung Electronics Co., Ltd., Suwon-si (KR)

(21) Appl. No.: 13/861,068

(22) Filed: Apr. 11, 2013

Related U.S. Application Data
(60) Provisional application No. 61/623,735, filed on Apr. 13, 2012.

(30) Foreign Application Priority Data
Oct. 18, 2012 (KR) 10-2012-0116023

(51) Int. Cl. H04N 21/43

(52) U.S. Cl. CPC H04N 21/4302
USPC 725/110

(57) ABSTRACT

A receiving apparatus is provided. The receiving apparatus includes a first receiver which receives a first signal through a radio frequency (RF) broadcast network, a second receiver which receives a second signal through an internet protocol (IP) communication network, and a signal processor which detects pair type information from at least one of the first signal and the second signal, selects pair information, corresponding to the pair type information, from among the pair information included in the at least one of the first signal and the second signal, and synchronizes the first signal and the second signal with each other according to the selected pair information. Accordingly, different signals are synchronized and output.

### CROSS-REFERENCE TO RELATED APPLICATION

This application claims priority from U.S. Provisional Patent Application No. 61/623,735, filed on Apr. 13, 2012, in the United States Patents and Trademark Office, and Korean Patent Application No. 10-2012-0116023, filed on Oct. 18, 2012, in the Korean Intellectual Property Office, the disclosure of which is incorporated herein by reference in its entirety.

### BACKGROUND

1. Field

Methods and apparatuses consistent with exemplary embodiments relate to a receiving apparatus and a method for processing signals. More particularly, embodiments relate to a receiving apparatus, which synchronizes a plurality of signals received through different paths, and a method for processing signals thereof.

2. Description of the Related Art

In the development of electronic technologies, various kinds of electronic apparatuses have been developed and distributed. A receiving apparatus, e.g., a television (TV), is a representative example of the electronic apparatuses.

As performance of the modern TV has been improved, multi-media contents, e.g., 3D contents or full high definition (HD) contents, are also serviced. Such types of contents have larger data than that of existing contents.

However, a transmission bandwidth used in a broadcast network is limited. Therefore, a size of a content transmittable through the current broadcast network is also limited. To overcome a limitation of the transmission bandwidth in the related art, resolution is unavoidably reduced. Therefore, there is a problem that image quality deteriorates.

To solve this problem, there has been attempts in the related art to provide various types of media data through various transmission environments. However, since such data is transmitted through a different path, a receiver may not know whether the data are related to each other. Thus, in the related art, the receiver is not able to appropriately synchronize the data.

Therefore, there is a demand for a method for appropriately synchronizing various contents.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments may provide a receiving apparatus, which receives a plurality of signals transmitted through different networks, synchronizes the signals with one another, and outputs the signals, and a method for processing signals thereof.

According to an aspect of an exemplary embodiment, there is provided a receiving apparatus including: a first receiver which receives a first signal through a radio frequency (RF) broadcast network; a second receiver which receives a second signal through an internet protocol (IP) communication network; and a signal processor which detects pair type information from at least one of the first signal and the second signal, selects pair information corresponding to the pair type information from among the pair information included in the at least one of the first signal and the second signal, and synchronizes the first signal and the second signal with each other according to the selected pair information.

The signal processor may detect the pair type information from a reserved area or a descriptor area in a Program Map Table (PMT) of at least one of the first signal and the second signal.

The signal processor may detect the pair type information from a reserved area or a descriptor area of a Program and System Information Protocol Virtual Channel Table (PSIP VCT) or an Event Information Table (EIT) of the at least one of the first signal and the second signal.

The signal processor may detect the pair type information from a private stream or a metadata stream which is included in the at least one of the first signal and the second signal.

The signal processor may include: a first demuxer which demuxes the first signal and detects first video data; a second demuxer which, if the second signal has a transport stream format, demuxes the second signal and detects second video data; a filer parser which, if the second signal has a file format, parses the second signal and detects the second video data; a first decoder which decodes the first video data demuxed by the first demuxer; a second decoder which decodes the second video data detected by the second demuxer or the file parser; and a renderer which performs rendering by combining the first video data decoded by the first decoder and the second video data decoded by the second decoder.

At least one of the first demuxer, the second demuxer, the file parser, the first decoder, the second decoder, and the renderer may be selectively operated according to a value of the pair type information, and may detect the pair information.

The signal processor may include: a first demuxer which demuxes the first signal and detects first video data; a second demuxer which, if the second signal has a transport stream format, demuxes the second signal and detects second video data; a filer parser which, if the second signal has a file format, parses the second signal and detects the second video data; a first decoder which decodes the first video data demuxed by the first demuxer; a second decoder which decodes the second video data detected by the second demuxer or the file parser; a renderer which performs rendering by combining the first video data decoded by the first decoder and the second video data decoded by the second decoder; and a controller which detects the pair type information from the at least one of the first signal and the second signal, and controls at least one of the first demuxer, the second demuxer, the file parser, the first decoder, the second decoder, and the renderer to detect the pair information according to the pair type information and perform synchronization.

If the pair type information designates a time code or a frame number which is recorded in a Packetized Elementary Stream (PES) level as the pair information, the controller may control the first demuxer and the second demuxer or the first demuxer and the file parser to detect video data which has a same time code or a frame number. If the pair type information designates the time code or the frame number which is recorded in an Elementary Stream (ES) level as the pair information, the controller may control the first decoder and the second decoder to decode the first signal and the second signal and then output video data which has a same time code or a frame number. If the pair type information designates the time code or the frame number which is recorded in a video level as the pair information, the controller may control the renderer to detect video data which has a same time code or a frame number from the decoded first signal and the decoded second signal, respectively, and render the video data.

The pair type information may include one of a first value which designates a video level watermark time code as the pair information, a second value which designates a video level watermark frame number as the pair information, a third value which designates an Elementary Stream (ES) level Society of Motion Pictures and Television Engineers (SMPTE) time code as the pair information, a fourth value which designates a PES level SMPTE time code as the pair information, a fifth value which designates a PES level frame number as the pair information, a sixth value which designates a PES level counterpart Presentation Time Stamp (PTS) as the pair information, and a seventh value which designates a video level watermark counterpart PTS as the pair information.

The first signal may include one of left-eye image data and right-eye image data of a 3D content, and the second signal may include the other one of the left-eye image data and the right-eye image data of the 3D content.

One of the first signal and the second signal may include a 2D content data, and the other one of the first signal and the second signal may include at least one of multilingual audio data, multilingual subtitle data, ultra-high definition (UHD) broadcast data, depth map data, and other view point data corresponding to the 2D content data.

According to an aspect of another exemplary embodiment, there is provided a method for processing signals of a receiving apparatus, the method including: receiving a first signal and a second signal through a radio frequency (RF) broadcast network and an internet protocol (IP) communication network, respectively; detecting pair type information from at least one of the first signal and the second signal; and processing signals by selecting pair information corresponding to the pair type information from among the pair information included in the at least one of the first signal and the second signal, and synchronizing the first signal and the second signal with each other according to the selected pair information.

The pair type information may be recorded on a reserved area or a descriptor area in a Program Map Table (PMT) of the at least one of the first signal and the second signal.

The pair type information may be recorded on a reserved area or a descriptor area of a Program and System Information Virtual Channel Table (PSIP VCT) or an Event Information Table (EIT) of the at least one of the first signal and the second signal.

The pair type information may be recorded on a private stream or a metadata stream which is included in the at least one of the first signal and the second signal.

The pair type information may include one of a first value which designates a video level watermark time code as the pair information, a second value which designates a video level watermark frame number as the pair information, a third value which designates an Elementary Stream (ES) level Society of Motion Picture and Television Engineers (SMPTE) time code as the pair information, a fourth value which designates a PES level SMPTE time code as the pair information, a fifth value which designates a PES level frame number as the pair information, a sixth value which designates a PES level counterpart PTS as the pair information, and a seventh value which designates a video level watermark counterpart Presentation Time Stamp (PTS) as the pair information.

According to a further aspect of another exemplary embodiment, there is provided a non-transitory computer readable medium storing a program causing a computer to execute a process, the process including: receiving a first signal and a second signal through a radio frequency (RF) broadcast network and an internet protocol (IP) communication network, respectively; detecting pair type information from at least one of the first signal and the second signal; selecting pair information, corresponding to the pair type information, from among the pair information included in the at least one of the first signal and the second signal; and synchronizing the first signal and the second signal with each other according to the selected pair information.

The first signal and the second signal may include a single multimedia content.

According to the various exemplary embodiments as described above, data included in a plurality of signals received through a plurality of different communication networks can be synchronized using pair type information, which designates an appropriate pair signal. Accordingly, appropriate pair information can be used according to a situation.

### BRIEF DESCRIPTION OF THE DRAWING FIGURES

The above and/or other aspects will be more apparent by describing in detail exemplary embodiments, with reference to the accompanying drawings, in which:

FIG. 1 is a block diagram illustrating a transmitting and receiving system according to an exemplary embodiment;

FIG. 2 is a table illustrating examples of pair type information;

FIGS. 3 to 10 are views illustrating a method for transmitting pair type information and a structure of pair type information according to various exemplary embodiments;

FIG. 11 is a view to explain a configuration and an operation of a transmitting system according to an exemplary embodiment;

FIG. 12 is a view to explain a configuration and an operation of a receiving apparatus according to an exemplary embodiment;

FIG. 13 is a view illustrating an example of a structure in which a time code is recorded on a group of picture (GOP) header;

FIG. 14 is a view to explain a method for transmitting a time code using supplemental enhancement information (SEI) defined in advanced video coding (AVC: ISO/IEC 14496-10);

FIG. 15 is a view illustrating an example of pair type information of a watermark format which is carried in an elementary stream (ES) payload of a first signal which is transmitted through a radio frequency (RF) broadcast network;

FIG. 16 is a view illustrating an example of pair type information of a watermark format which is carried in an ES payload of a second signal which is transmitted through an internet protocol (IP) network;

FIG. 17 is a view illustrating an example of pair type information which is carried in a second signal based on an MP4 file format;

FIG. 18 is a view to explain a configuration and an operation of a transmitting system according to another exemplary embodiment;

FIG. 19 is a view to explain a configuration and an operation of a receiving apparatus according to another exemplary embodiment;

FIG. 20 is a view illustrating an example of packetized elementary stream (PES) level pair type information of a first signal which is transmitted through an RF broadcast network;

FIG. 21 is a view illustrating an example of PES level pair type information of a second signal which is transmitted through an IP communication network;

FIG. 22 is a view illustrating an example of PES level pair type information which is carried in a second signal based on an MP4 file format;

FIG. 23 is a view illustrating a configuration and an operation of a transmitting system according to still another exemplary embodiment;

FIG. 24 is a view illustrating a configuration and an operation of a receiving apparatus according to still another exemplary embodiment;

FIG. 25 is a table illustrating pair type information to which a value designating a PES level counterpart presentation time stamp (PTS) as pair information is added;

FIG. 26 is a view illustrating an example of a signal format which includes a PES level counterpart PTS;

FIG. 27 is a table illustrating pair type information to which a value designating a video level watermark counterpart PTS as pair information is added;

FIG. 28 is a view to explain a method for transmitting pair type information through a private stream or a metadata stream of a first signal which is transmitted through an RF broadcast network;

FIG. 29 is a view to explain a method for transmitting pair type information through a private stream or a metadata stream of a second signal which is transmitted through an IP communication network;

FIG. 30 is a view to explain a method for transmitting pair type information through a private stream or a metadata stream of a second signal based on an MP4 file format;

FIG. 31 is a table to explain syntax of pair type information;

FIG. 32 is a view illustrating another example of a configuration of a signal processor; and

FIG. 33 is a flowchart to explain a method for processing signals of a receiving apparatus according to an exemplary embodiment.

### DETAILED DESCRIPTION OF EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of exemplary embodiments. Thus, it is apparent that exemplary embodiments can be carried out without those specifically defined matters. Also, functions or elements known in the related art are not described in detail since they would obscure the exemplary embodiments with unnecessary detail.

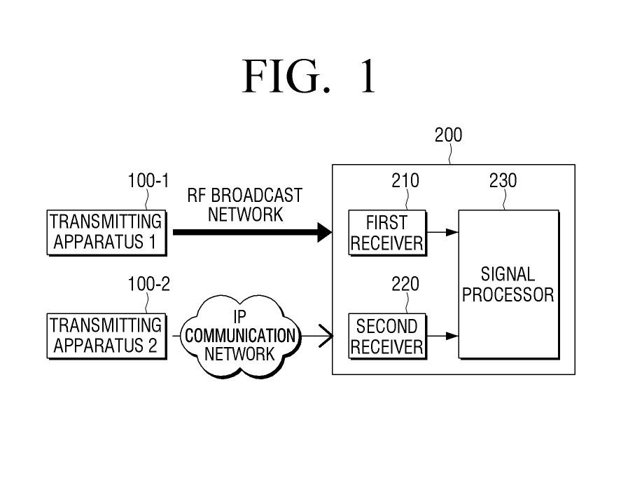

FIG. 1 is a block diagram illustrating a transmitting and receiving system according to an exemplary embodiment. Referring to FIG. 1, a transmitting and receiving system includes a plurality of transmitting apparatuses 1 and 2 (i.e., 100-1 and 100-2, respectively), and a receiving apparatus 200.

The transmitting apparatuses 1 and 2 transmit different signals through different paths. For example, the transmitting apparatus 1 transmits a first signal through a radio frequency (RF) broadcast network, and the transmitting apparatus 2 transmits a second signal through an internet protocol (IP) communication network.

The first and second signals include different data, constituting a single multimedia content. For example, in the case of a 3D content, a left-eye image and a right-eye image may be included in the first signal and the second signal, respectively. Also, a content may be divided into video data and audio data or may be divided into moving image data and subtitle data, etc., and may be included in the first signal or the second signal.

The first signal includes first pair information along with first data, and the second signal includes second pair information along with second data.

The first and second pair information may use diverse information. Specifically, the pair information may be a society of motion picture and television engineers (SMPTE) time code, a frame number, or other diverse information according to its type, and may be divided into a video level, an ES level, and a PES level according to a providing method thereof.

The transmitting apparatuses 1 and 2 may provide the pair information in various formats and methods according to a type of a content, a transmission environment, an encoding method, and a size of a content. An identifier is needed to identify such pair information which is provided in various formats and methods.

Pair type information refers to such an identifier. In other words, the pair type information refers to a value that designates information from among various pieces of information included in at least one of the first and second signals as pair information. Alternatively, the pair type information may be called a pair type or a media pair type.

The receiving apparatus 200 identifies the pair type information transmitted from at least one of the transmitting apparatuses 1 and 2, and detects information designated as the pair information from the first and second signals. The receiving apparatus 200 compares the detected pair information, synchronizes the first and second signals with each other, and outputs the synchronized signals.

Referring to FIG. 1, the receiving apparatus 200 includes a first receiver 210, a second receiver 220, and a signal processor 230.

The first receiver 210 receives the first signal through the RF broadcast network. The second receiver 220 receives the second signal through the IP communication network.

The second signal may be transmitted in a real time transport stream format or an MP4 file format. If the second signal is transmitted in the real time transport stream format, the second signal may be transmitted and received using a protocol, e.g., a real-time transport protocol (RTP) or a hypertext transfer protocol (HTTP). If the HTTP is used, a metadata file should be provided so that the second signal can be obtained.

The metadata refers to information that informs where a multimedia content can be received. The metadata file may include information that a client should know in advance, such as a location of each of a plurality of separated files on a content time, an URL of a source which provides a corresponding file, and a size of a file. The metadata file may be classified variously according to a type of an HTTP-based streaming. In other words, in the case of a smooth streaming method, an internet information service (IIS) smooth streaming media (ISM) file may be used as a metadata file. Also, in the case of an internet engineering task force (IETF) HTTP live streaming method, an m3v8 file may be used as a metadata file. In the case of an adaptive HTTP streaming Rel. 9 employed in 3GPP, an adaptive HTTP streaming Rel. 2 employed in OIPF, or a dynamic adaptive streaming over HTTP method employed in MPEG, media presentation description (MPD) may be used as a metadata file. The second receiver 220 detects address information on a source from which the metadata file is obtained, from the first signal, accesses the source and obtains the metadata file, and then receives the second signal using the metadata file. According to another exemplary embodiment, the metadata file may be directly included in the first signal. In this case, the second receiver 220 may directly obtain the metadata file from the first signal and may receive the second signal.

The signal processor 230 detects pair type information from at least one of the first and second signals. The signal processor 230 selects pair information corresponding to the pair type information from among the pair information included in the first and second signals. The signal processor 230 synchronizes the first and second signals with each other according to the selected pair information, and outputs the synchronized signals.

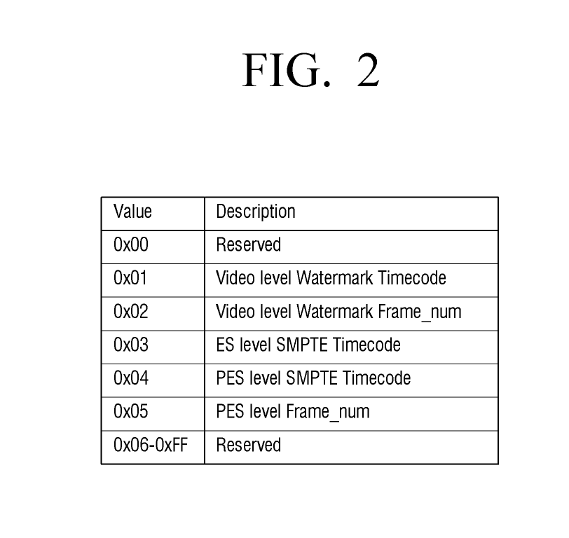

FIG. 2 is a table to explain various examples of pair type information. Referring to FIG. 2, the pair type information includes a first value which designates a video level watermark time code as pair information, a second value which designates a video level watermark frame number as pair information, a third value which designates an ES level SMPTE time code as pair information, a fourth value which designates a PES level SMPTE time code as pair information, and a fifth value which designates a PES level frame number as pair information. The first to fifth values may be expressed by bit values such as 0x01, 0x02, 0x03, 0x04, and 0x05.

The video level recited herein means that pair information is carried in a video data payload area of a PES packet. The ES level means that pair information that is carried in a video data ES header area of a PES packet. The PES level means that pair information is carried in a payload area of a data packet which is separately provided in a PES packet.

The time code is a series of pulse signals that is generated by a time code generator and is a signal standard which is developed to manage editing easily. When a content is generated and edited, the same time code is used to manage synchronized left-eye image and right-eye image. Accordingly, the time code may maintain the same pair regardless of when a stream is generated or sent. Specifically, an SMPTE time code may be used. That is, the SMPTE 12M expresses a time code in the form of “clock:minute:second:frame”. The SMPTE time code may be divided into a longitude time code (LTC) or a vertical interval time code (VITC) according to a recording method. The LTC may consist of data of 80 bits in total, including visual information (25 bits), user information (32 bits), pair information (16 bits), a reserved area (4 bits), and frame mode display (2 bits). The VITC is recorded on two horizontal lines, within a vertical blanking interval of a video signal. The SMPTE RP-188 defines an interface standard to allow a time code of an LTC or VITC type to be transmitted as ancillary data.

The frame number refers to identification information, e.g., a number assigned to each frame. The frame number may be recorded on an event information table (EIT), a program map table (PMT), a private stream, and a transport stream header of the first or second signal.

As described above, the receiving apparatus 200 detects the time code or the frame number according to the pair type information and synchronizes the signals based on the detected information. A method for synchronizing the signals using the time code or the frame number will be explained in detail below.

The pair type information for designating a type of pair information may be transmitted in various methods, which include a first method in which the pair type information is transmitted using a reserved area or a descriptor area in a PMT, a second method in which the pair type information is transmitted using a reserved area or a descriptor area of a program and system information protocol virtual channel table (PSIP VCT) or an event information table (EIT), and a third method in which the pair type information is transmitted using a private stream or a metadata stream.

Hereinafter, various examples of a method for transmitting pair type information will be explained.

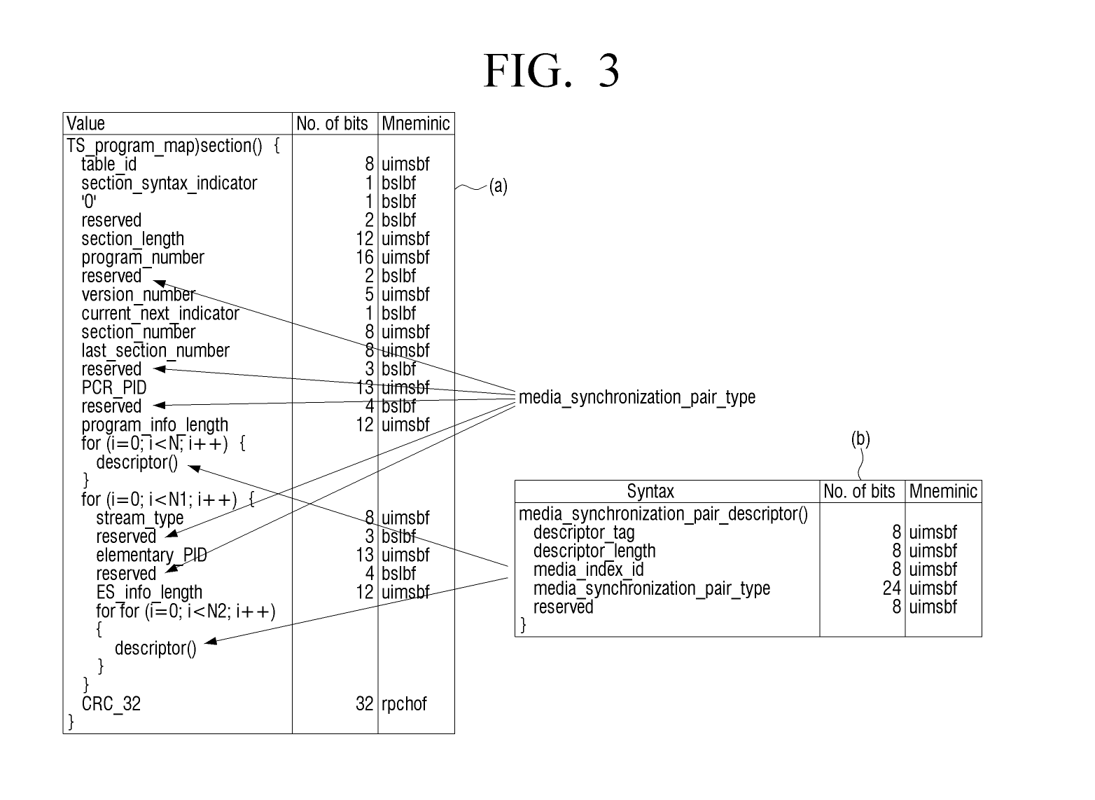

FIG. 3 is a view to explain the first method in which the pair type information is transmitted using a reserved area or a descriptor area of a PMT. (a) of FIG. 3 illustrates a syntax of a program map table. Referring to (a) of FIG. 3, a reserved area and a descriptor are defined in the program map table. The pair type information may be recorded on such a reserved area or a descriptor area. (b) of FIG. 3 illustrates a syntax of a new descriptor, which is defined for the pair type information. Referring to (b) of FIG. 3, pair type information of 24 bits may be recorded on the new descriptor.

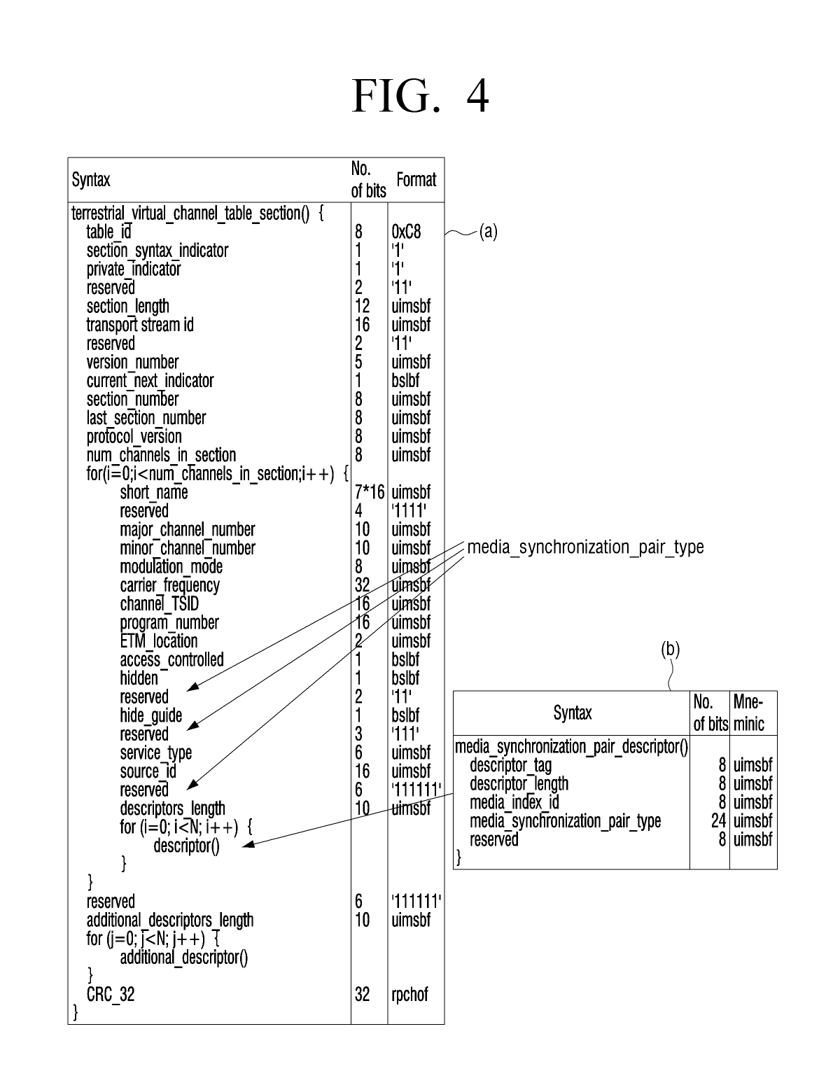

FIG. 4 is a view to explain the second method in which the pair type information is transmitted using a reserved area or a descriptor area of a PSIP VCT.

(a) of FIG. 4 illustrates a bit stream syntax of a VCT, which provides channel or event information in the ATSC A65. Referring to FIG. 4, the pair type information may be recorded on the reserved area or the descriptor area in the VCT. (b) of FIG. 4 illustrates syntax of pair type information, which is recorded on the descriptor area.

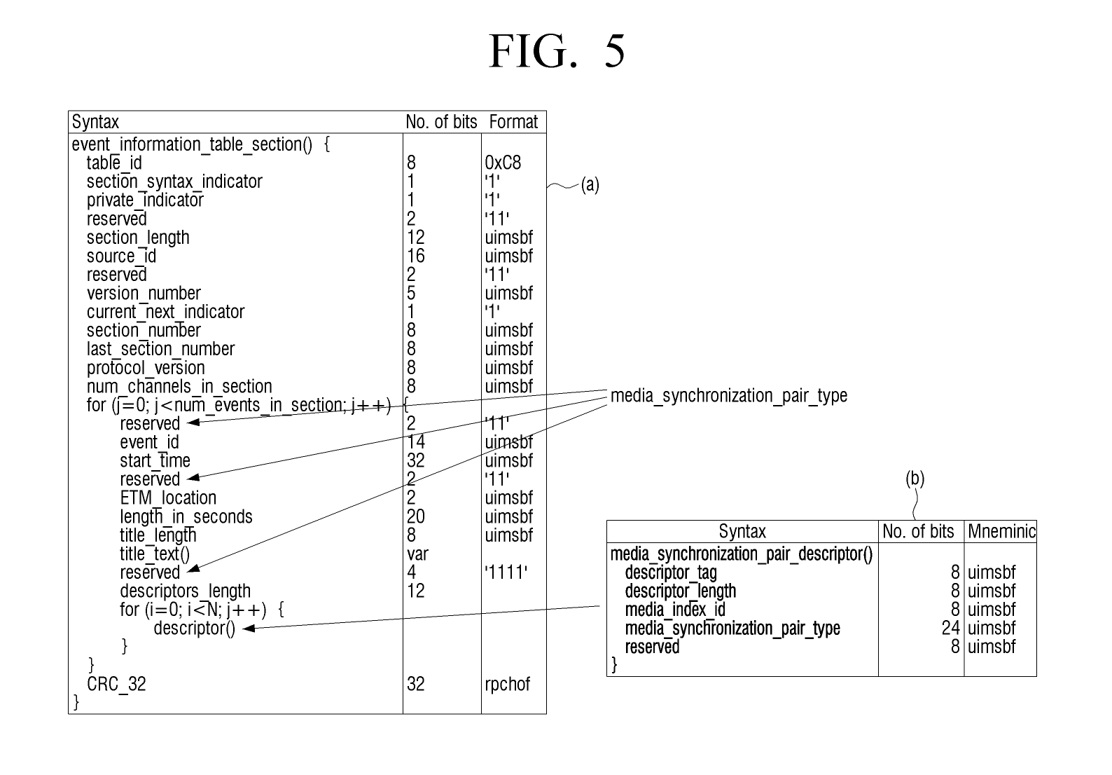

FIG. 5 is a view to explain the second method in which the pair type information is transmitted using a reserved area or a descriptor area of an event information table (EIT). (a) of FIG. 5 illustrates bit stream syntax of an EIT. Referring to FIG. 5, the pair type information may be recorded on the reserved area or the descriptor area of the EIT. (b) of FIG. 5 illustrates syntax of pair type information, which is recorded on the descriptor area.

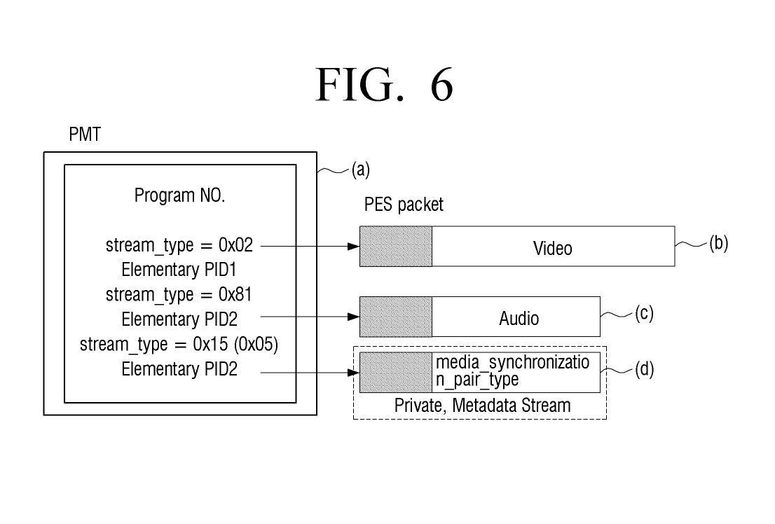

FIG. 6 is a view to explain the third method in which the pair type information is transmitted using a private stream or a metadata stream. In the third method, the pair type information may be provided using a structure of the private stream or the metadata stream for providing additional information or additional data. The private stream is defined by one of stream types=0x05 and 0x06, and the metadata stream is defined by one of stream types=0x14, 0x15, and 0x16 in the PMT. In (a) to (d) of FIG. 6, the pair type information is provided using the private stream or the metadata stream, which is defined by stream type=0x15 or 0x05, other than the PES video packet (b) and the audio packet (c).

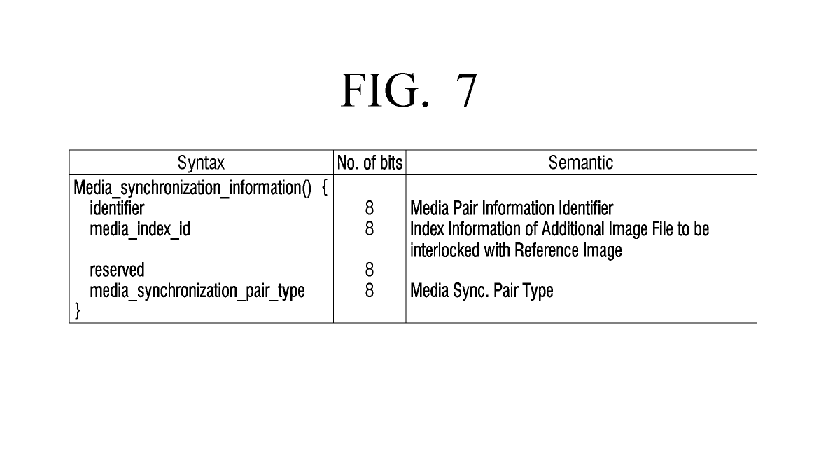

FIG. 7 is a table to explain syntax of pair type information, which is provided through a stream as shown in (d) of FIG. 6. Referring to FIG. 7, pair type information (media_synchronization_pair_type) consists of 8 bits.

As described above, the pair type information may be transmitted in various methods. Hereinafter, a format of pair information according to pair type information and a method for providing pair information will be explained.

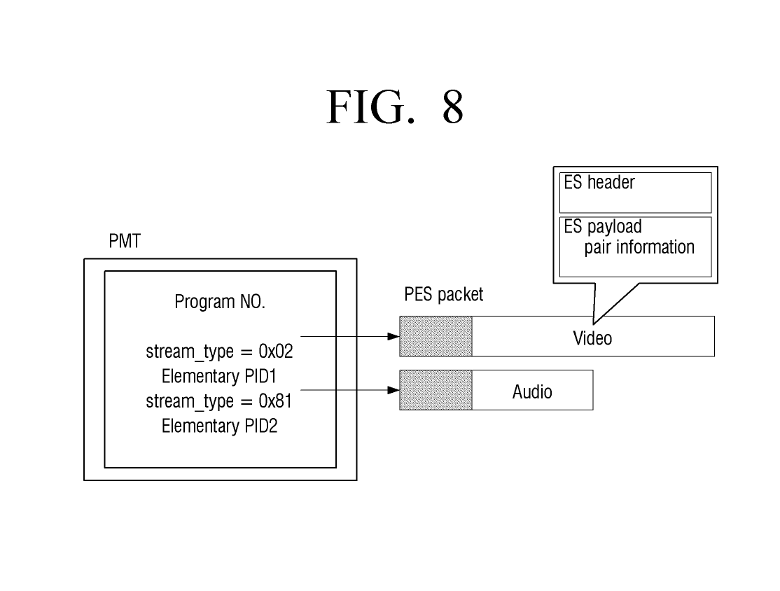

FIGS. 8 to 12 are views illustrating a structure of pair information which is transmitted in a video level, and a configuration of a transmitting and receiving system using the pair information.

Referring to the table shown in FIG. 2, if pair type information has a value of 0x01 or 0x02, pair information is provided in a video level. In other words, the pair information is inserted frame by frame through a video watermark method. The watermark may be divided into a method in which pair information is inserted into a space area and a method in which pair information is inserted into a frequency area. Specifically, the pair information may be inserted into a least significant bit (LSB) of an image in the space region or may be inserted after the space area is converted into the frequency area.

FIG. 8 is a view illustrating a providing format of a first signal which is transmitted through an RF broadcast network. Referring to FIG. 8, pair information of a watermark format is carried in an ES payload area of a video packet in which real video data is carried. The pair information may be information for correcting a PTS or DTS to solve inconsistency in PCR-based PTS or DTS pair information between two or more streams.

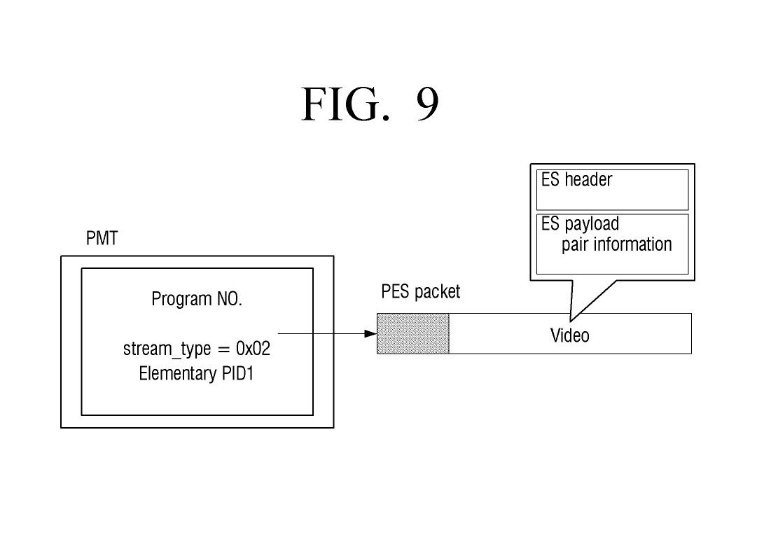

FIG. 9 is a view illustrating a providing format of a second signal which is transmitted in a transport stream format through an IP communication network. Referring to FIG. 9, pair information of a watermark format is carried in an ES payload area of a video packet, in which real video data is carried.

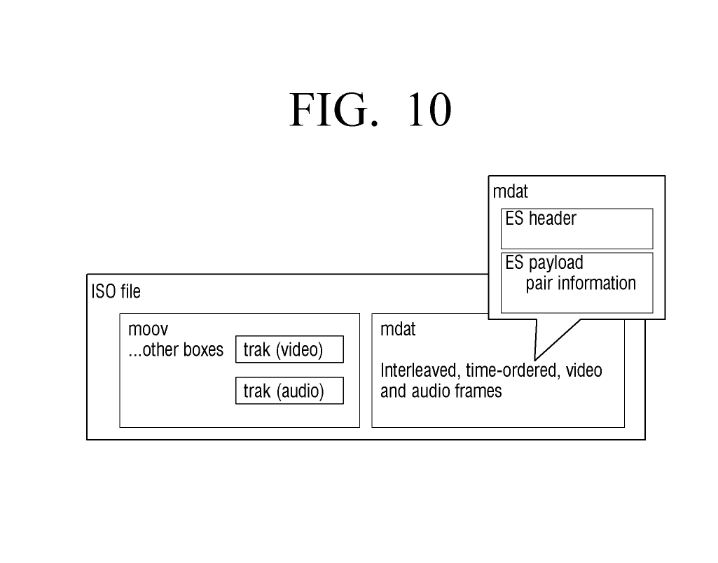

FIG. 10 is a view illustrating a format of a second signal, which is transmitted in an MP4 file format. Referring to FIG. 10, pair information of a watermark format may be carried in video data in an mdat area, in which a real video value is provided.

As described above, the pair information may be stored in various locations and the transmitting apparatuses 1 and 2 generate pair type information according to a location in which pair information to be used is stored and provide the pair type information to the receiving apparatus 200.

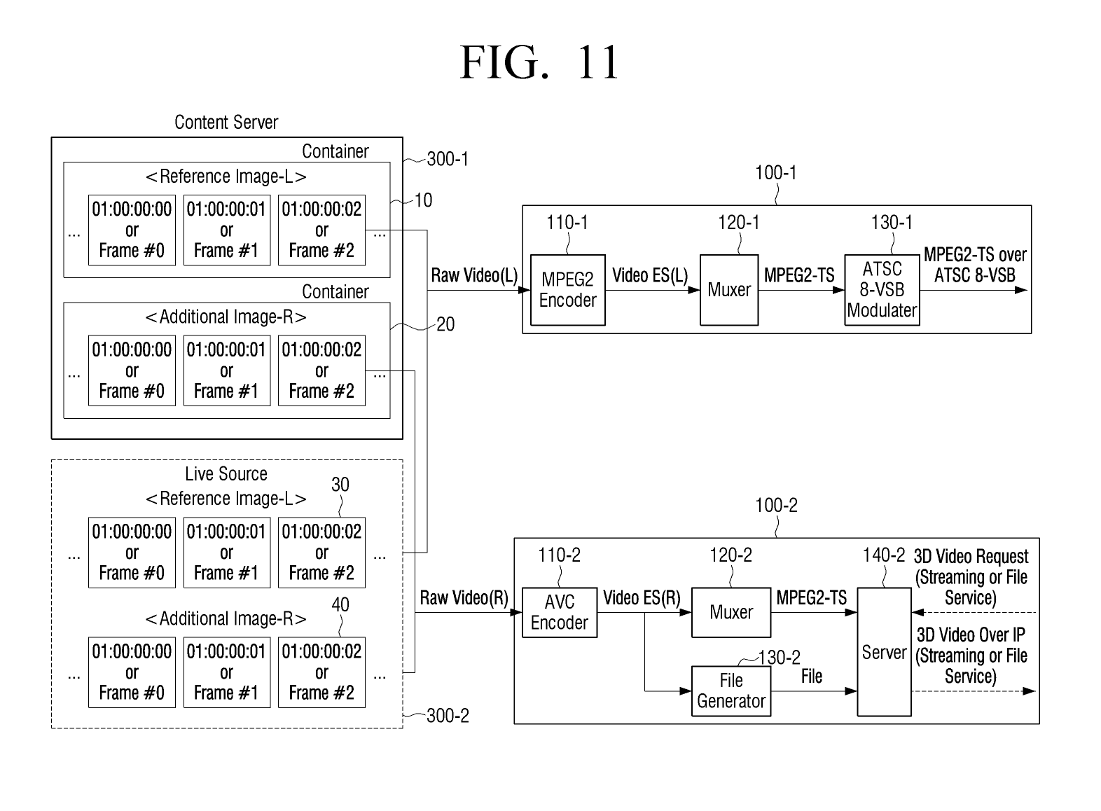

FIG. 11 is a view illustrating a configuration of a transmitting system including transmitting apparatuses 1 and 2 (i.e., 100-1 and 100-2, respectively). Referring to FIG. 11, the transmitting system includes a plurality of source apparatuses 300-1 and 300-2, a transmitting apparatus 1 and a transmitting apparatus 2.

The source apparatus 300-1 refers to a content server which provides an already recorded content, and the source apparatus 300-2 refers to a live source which provides a content on a real time basis. Raw video provided by the source apparatuses 300-1 and 300-2 includes pair information in a watermark format. In FIG. 11, a time code which is added to each frame in sequence, e.g., 01.00.00.00, 01.00.00.01, and 01.00.00.02 or a frame number, e.g., frame #1, #2, and #3 may be included in the watermark format.

In FIG. 11, the source apparatuses 300-1 and 300-2 provide left-eye raw video data to the transmitting apparatus 1 and provide right-eye raw video data to the transmitting apparatus 2. However, this is merely an example and data of the source apparatus 300-1 may be provided to the transmitting apparatus 1 and data of the source apparatus 300-2 may be provided to the transmitting apparatus 2.

The transmitting apparatus 1 includes an encoder 110-1, a muxer 120-1, and a modulator 130-1. The encoder 110-1 encodes the raw data in an MPEG2 encoding method and generates a video ES, and provides the video ES to the muxer 120-1. The muxer 120-1 muxes additional data regarding the video ES and generates an MPEG2-transport stream (TS), and provides the MPEG2-TS to the modulator 130-1.

The modulator 130-1 modulates the data in an ATSC 8-VSB modulating method and outputs the data.

The transmitting apparatus 2 includes an encoder 110-2, a muxer 120-2, a file generator 130-2, and a server 140-2. The encoder 110-2 encodes the raw data in an advanced video coding (AVC) method and generates a video ES. The encoder 110-2 may provide the video ES to the muxer 120-2 if a content is transmitted in a TS format. The muxer 120-2 muxes additional data regarding the video ES and provides the data to the sever 140-2.

If a content is transmitted in an MP4 file format, the encoder 110-2 may provide the video ES to the file generator 130-2. The file generator 130-2 converts the video ES into a file format and provides the file format to the server 140-2.

The server 140-2 stores the video data provided from the muxer 120-2 or the file generator 130-2. If a request for video data (a video request) is received from the receiving apparatus 200, the server 140-2 streams the stored TS through the IP communication network according to the request or may provide the stored file to the receiving apparatus 20 through the IP communication network. Although a request for 3D video data is received in FIG. 11, the same processing is performed for 2D video data or other audio data.

In FIG. 11, pair type information may be inserted into a PMT, PSIP VCT, or EIT in the TS or the file by the encoders 110-1 and 110-2 and the muxers 120-1 and 120-2, or may be generated as a separate private stream or metadata stream. Such pair type information may be provided from the source apparatuses 300-1 and 300-2, may be generated by the encoders 110-1 and 110-2 and the muxers 120-1 and 120-2, and may use a value which is stored in a separate storage (not shown). Alternatively, the pair type information may be generated by a separate controller (not shown) and may be provided to the encoders 110-1 and 110-2 or the muxers 120-1 and 120-2. If the controller is provided, the controller may selectively determine pair information to be used according to a user command which is input to the transmitting apparatuses 1 and 2. If the pair information is determined, the controller may generate pair type information corresponding to the determined pair information and a transmitting method thereof, and may provide the pair type information to the encoders 110-1 and 110-2 or the muxers 120-1 and 120-2.

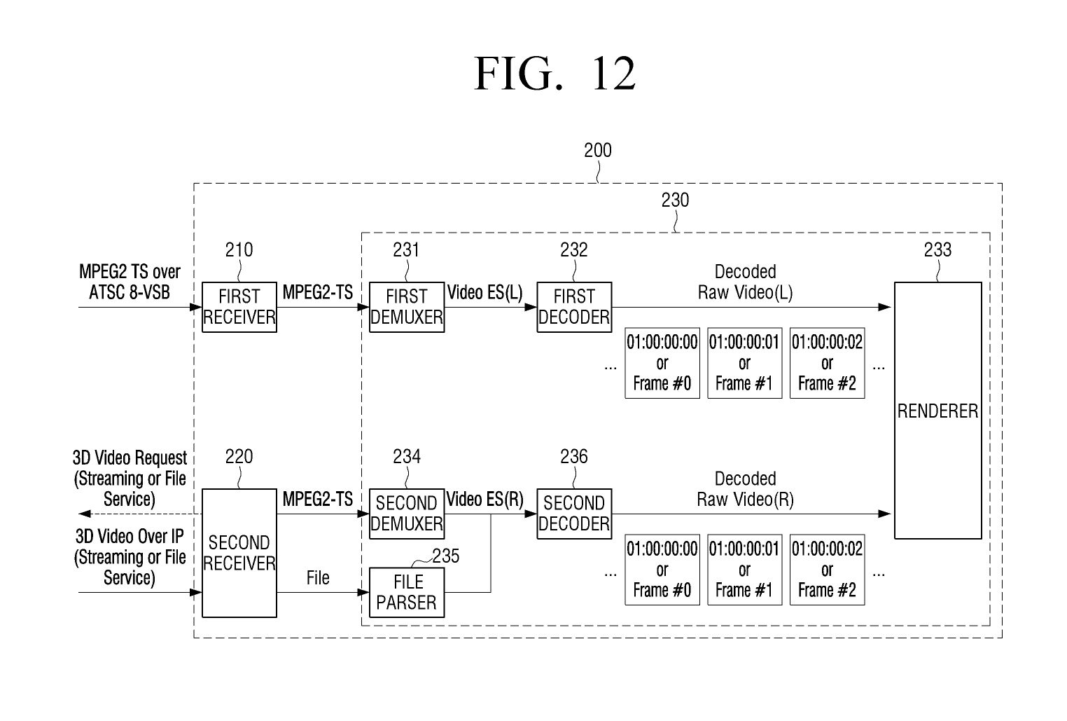

FIG. 12 is a view illustrating an example of a configuration of a receiving apparatus which receives first and second signals transmitted from the transmitting system of FIG. 11. Referring to FIG. 12, the receiving apparatus includes a first receiver 210, a second receiver 220, and a signal processor 230.

The first receiver 210 receives a first signal through an RF broadcast network. The second receiver 220 receives a second signal through an IP communication network.

The signal processor 230 detects pair type information from at least one of the first signal and the second signal. The signal processor 230 selects pair information corresponding to the pair type information from the pair information included in the first signal and the second signal, and synchronizes the first signal and the second signal with each other according to the selected pair information.

For example, if a time code is designated by the pair type information, the receiving apparatus 200 detects a time code recorded on a video frame of the first signal and a time code recorded on a video frame of the second signal. The signal processor 230 compares the detected time codes and selects video frames that have the same time code from among the video frames of the first signal and the video frames of the second signal. Also, the signal processor 230 identifies a time stamp difference between the selected video frames, and performs synchronization by correcting a time stamp according to the identified value. In other words, according to the MPEG standard, a transport stream for transmitting broadcast data includes a program clock reference (PCR) and a presentation time stamp (PTS). The PCR refers to reference time information based on which a receiving apparatus (a set-top box or a TV) conforming to the MPEG standard sets a clock reference according to that of transmitting apparatuses 100-1 and 100-2. The receiving apparatus 200 sets a value of a system time clock (STC) according to the PCR. The PTS refers to a time stamp that informs a reproducing time for synchronizing video and audio data in a broadcast system conforming to the MPEG standard. The PTS is referred to as a time stamp in this specification. If different signals are transmitted from different transmitting apparatuses 100-1 and 100-2 as shown in FIG. 1, a PCR may be different according to characteristics of the transmitting apparatuses 100-1 and 100-2. Therefore, even if the signals are reproduced according to a time stamp which is set according to the PCR, the signals may not be synchronized. If a time code is designated as pair information by pair type information, the signal processor 230 performs synchronization by correcting time stamps of video frames which have the same time code from among the video frames of each signal to be consistent with each other. Also, the signal processor 230 may perform synchronization by performing decoding, scaling and rendering with respect to the video frame with reference to the time code, without correcting the time stamp.

Frame index information, such as a frame number, may be designated as pair information by pair type information. The frame index information refers to identification information that is assigned to each frame. The representative example of the frame index information may be a frame number. The frame index information may be recorded on an event information table (EIT), a PMT, a private stream, or a transport stream header of a real time transport stream. The signal processor 230 may correct time stamps of frames that have the same frame index to be consistent with each other. Accordingly, if the video frames of each signal are processed based on the corrected time stamp, synchronization is naturally performed.

Referring to FIG. 12, the signal processor 230 includes a first demuxer 231, a first decoder 232, a renderer 233, a second demuxer 234, a file parser 235, and a second decoder 236. The first demuxer 231, the first decoder 232, the renderer 233, the second demuxer 234, the file parser 235, and the second decoder 236 are selectively operated according to a value of pair type information, and detect pair information.

Referring to FIG. 12, the first signal received by the first receiver 210 is transmitted to the first demuxer 231 in an MPEG2-TS format. The first demuxer 231 demuxes the received transport stream and outputs a video ES. The first decoder 232 is implemented by an MPEG2 decoder and decodes the video ES. The decoded raw data is provided to the renderer 233.

The second signal, received by the second receiver 220, may be received in an MPEG2-TS format or a file format. The MPEG2-TS refers to a transport stream that is encoded in an MPEG2 encoding method, is modulated in an ATSC 8VSB method, and is transmitted. The MPEG2-TS is transmitted to the second demuxer 234. The second demuxer 234 demuxes the received transport stream and detects the video ES, and provides the video ES to the second decoder 236. The second signal received in the file format is provided to the file parser 235. The file parser 235 parses the received file and provide a result of the parsing to the second decoder 236. The second decoder 236 decodes the video data which is provided from the second demuxer 234 or the file parser 235 in an AVC method, and provides the decoded video data to the renderer 233.

Referring to FIG. 12, the decoding data provided from the first decoder 232 and the second decoder 236, e.g., the raw data, may include pair information such as a time code or a frame number in a watermark format. As described above, the renderer 233 may detect the pair information included in each raw data in the watermark format, and may directly synchronize frames based on the pair information, or may correct the time stamp of each frame and may perform rendering according to the time stamp.

Next, the pair information may be transmitted in an ES level.

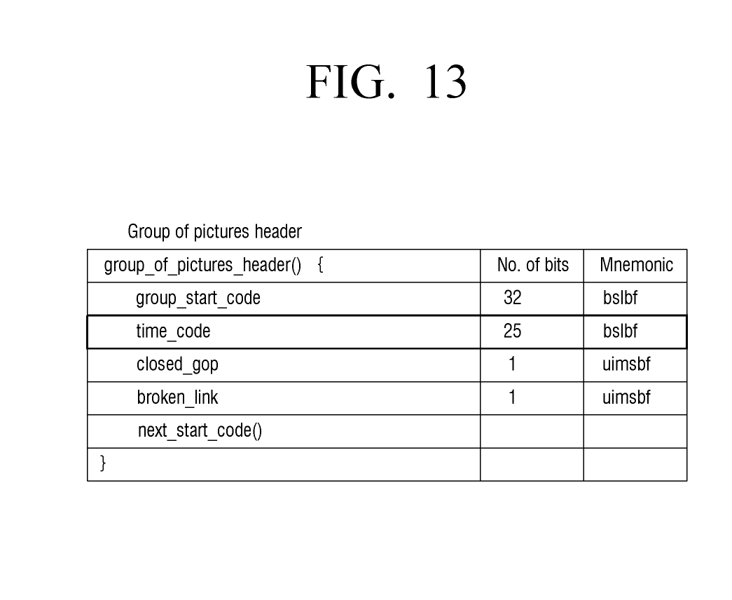

FIGS. 13 to 17 are views illustrating a structure of pair information which is transmitted in an ES level and a configuration of a transmitting and receiving system which uses the pair information.

Referring to the table shown in FIG. 2, if pair type information has a value of 0x03, pair information is provided in an ES level. In other words, the pair information may be inserted into an ES header area. Specifically, the pair information has a format of a SMPTE time code. In the case of the MPEG2, an SMPTE time code of an ES header level may be provided through a GOP header or a picture timing SEI of the AVC.

FIG. 13 illustrates an example of a syntax structure of a GOP header in an MPEG stream in which a time code is recorded on the GOP header. Referring to FIG. 13, the time code may be recorded as data of 25 bits. As show in FIG. 13, the time code may be transmitted to the receiving apparatus 200 in a unit of GOP.

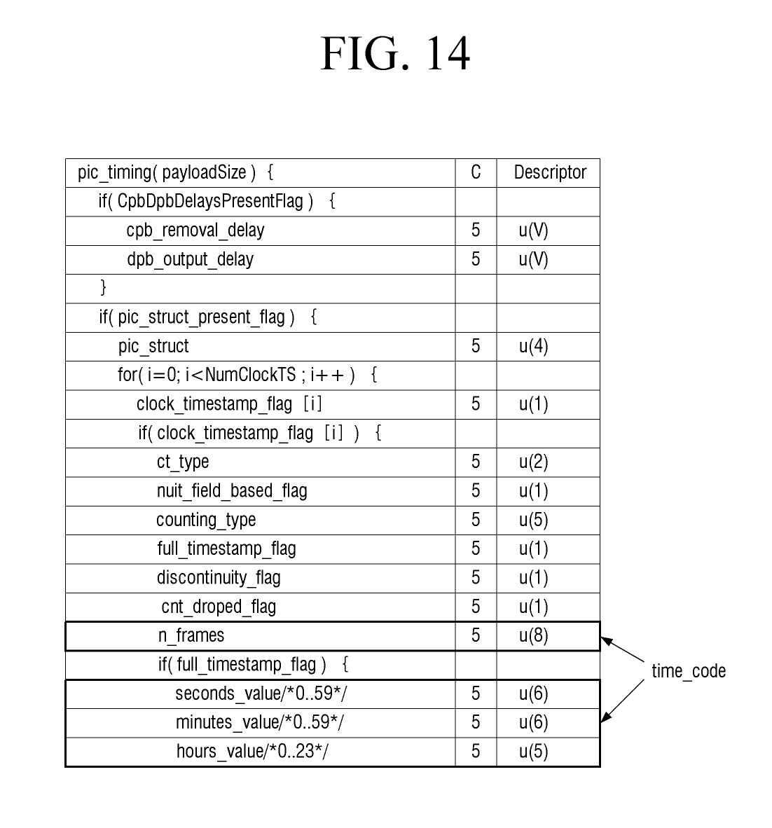

FIG. 14 illustrates a method for transmitting a time code using supplemental enhancement information (SEI) defined in advanced video coding (AVC) (ISO/IEC 14496-10). Referring to FIG. 14, the time code is transmitted using seconds_value, minutes_value, hours_value, and n_frames, which are defined in the picture timing SEI.

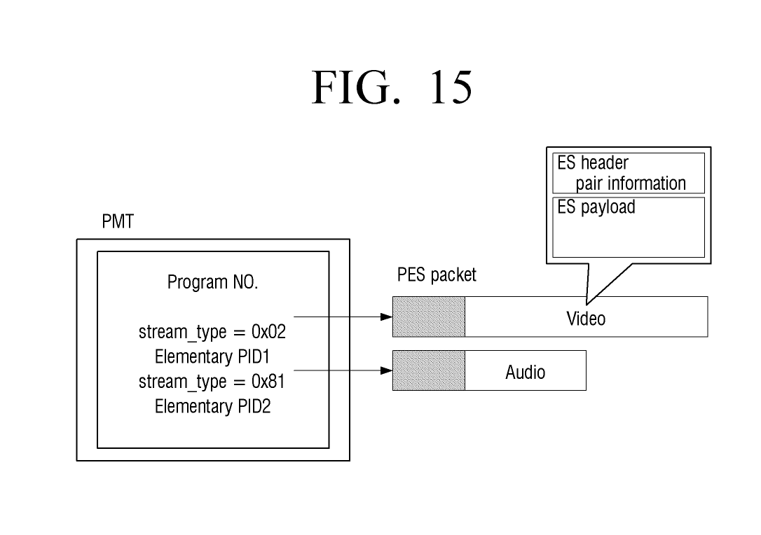

FIG. 15 is a view illustrating a providing format of a first signal, which is transmitted through an RF broadcast network. Referring to FIG. 15, a PES packet is transmitted according to a stream type which is defined in the PMT. An ES header of a video packet of the PES packet includes pair information.

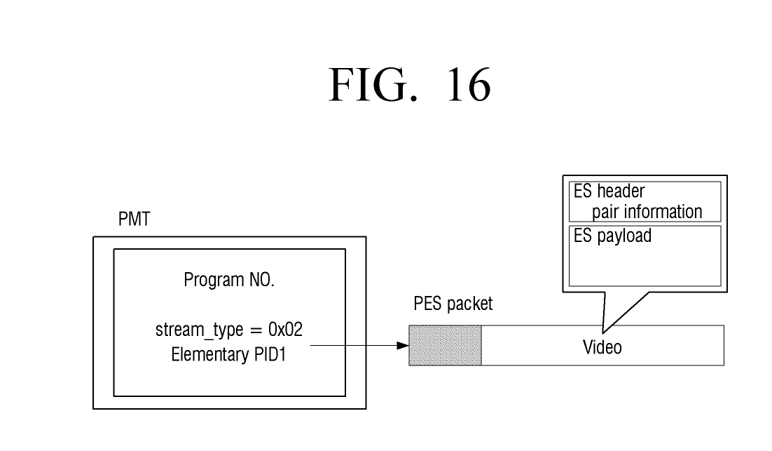

FIG. 16 is a view illustrating a providing format of a TS-based second signal, which is transmitted through an IP communication network. Referring to FIG. 16, pair information may be included in an ES header level in a format of an SMPTE time code and may be transmitted.

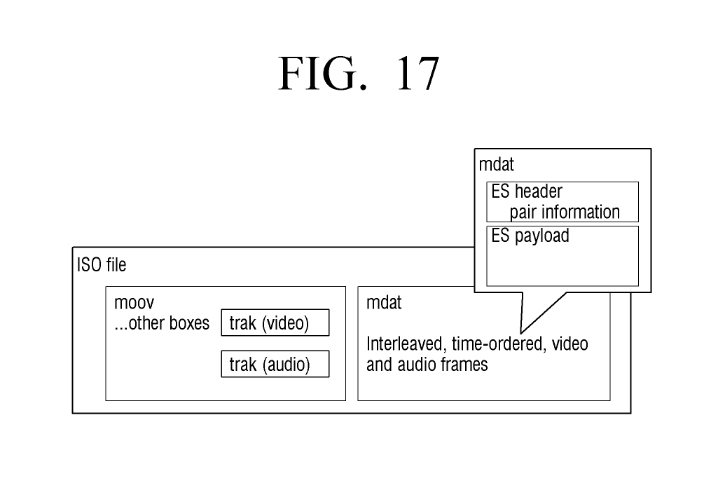

FIG. 17 is a view illustrating a providing format of an MP4 file format-based second signal, which is transmitted through an IP communication network. Referring to FIG. 17, pair information is included in an ES header of an mdat area in which a real video value is provided in a format of an SMPTE time code.

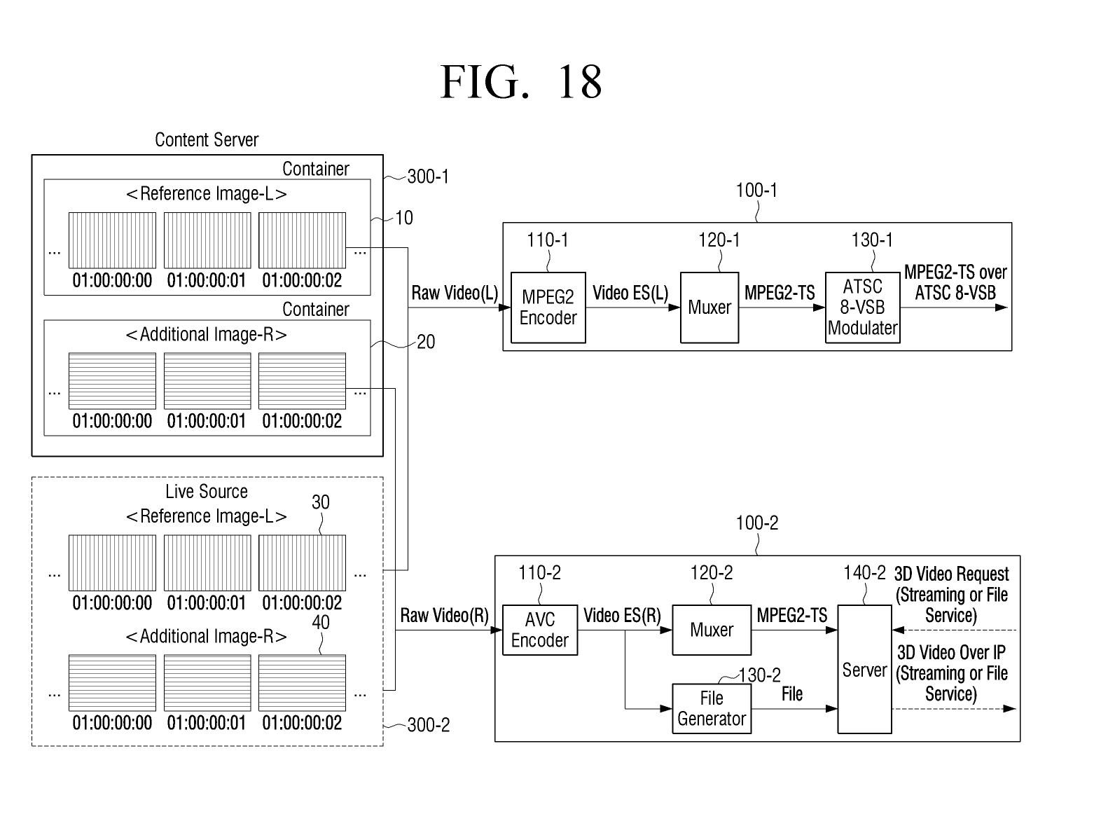

FIG. 18 is a configuration and an operation of a transmitting system which transmits a content in an ES level. Referring to FIG. 18, the transmitting system includes a plurality of sources apparatuses 300-1 and 300-2, a transmitting apparatus 1, and a transmitting apparatus 2. The basic configuration is the same as that of FIG. 11. Thus, an additional explanation is omitted.

Referring to FIG. 18, raw data transmitted from the source apparatus 300-1, which is implemented by a content server, and the source apparatus 300-2, which is implemented by a live source, includes an SMPTE time code in its VBI section. Accordingly, an MPEG2 encoder 110-1 and an AVC encoder 110-2, which are included in the transmitting apparatuses 1 and 2, respectively, capture the SMPTE time code and include the SMPTE time code in an ES level stream. Accordingly, muxers 120-1 and 120-2 and a file generator 130-2 generates a TS or a file including a time code in an ES level, and provides the TS or the file to elements at a rear end, i.e., a modulator 130-1 or a server 140-2.

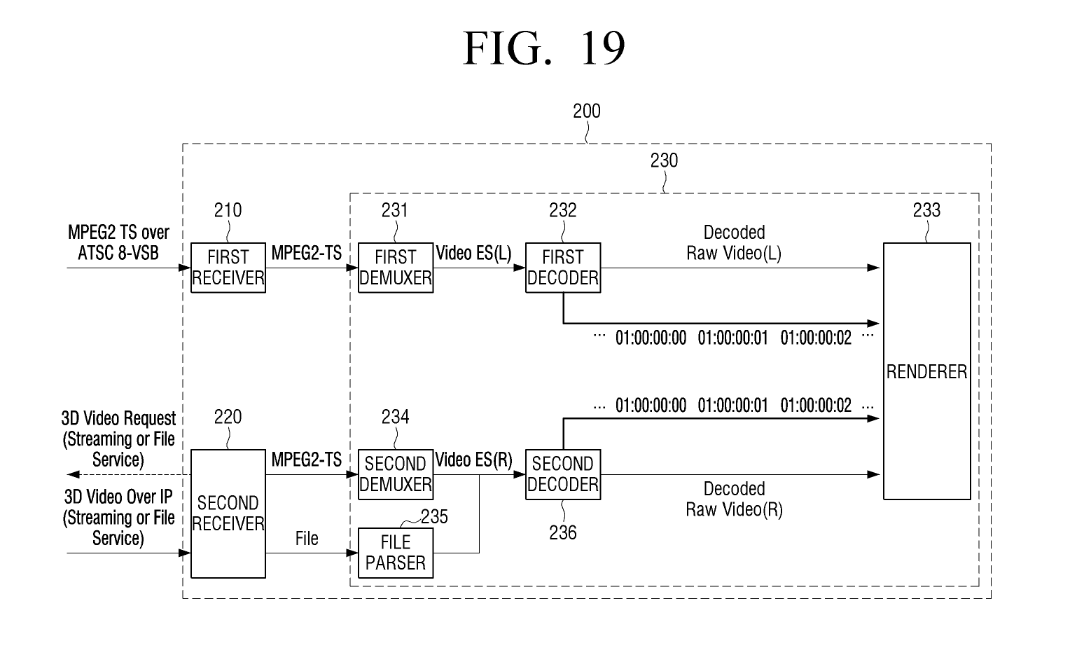

FIG. 19 is a view illustrating an example of a configuration of a receiving apparatus which uses pair information included in an ES level. The basic configuration of the receiving apparatus of FIG. 19 is the same as that of the receiving apparatus of FIG. 12. Thus, an additional explanation is omitted.

Referring to FIG. 19, a first receiver 210 and a second receiver 220 receive a first signal and a second signal, respectively, and provide the first signal and the second signal to a signal processor 230. Each of the received signals includes an SMPTE time code of an ES level, i.e., pair information.

A first decoder 232 and a second decoder 236 of the signal processor 230 extract the SMPTE time code which is provided in the ES level, and provide the SMPTE time code to a renderer 233. The renderer 233 compares the time code of the first signal and the time code of the second signal and performs synchronization so that frames having the same time code are synchronized and output. The method for performing synchronization has been described above. Thus, an additional explanation is omitted.

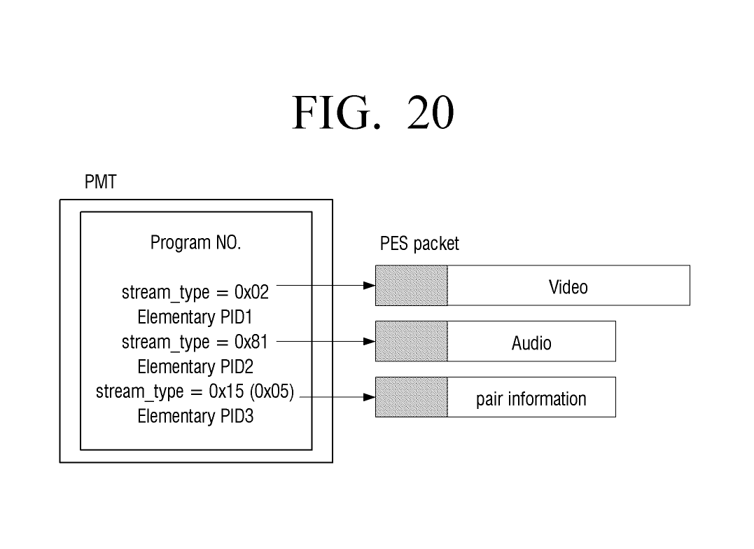

FIGS. 20 to 24 are views illustrating a structure of pair information, which is transmitted in a PES level and a configuration of a transmitting and receiving system, which uses the pair information.

Referring to the table shown in FIG. 2, if pair type information has a value of 0x04 or 0x05, pair information is provided in a PES level. Specifically, the pair information may be an SMPTE time code or a frame number. Such pair information may be transmitted through a private stream or a metadata PES stream having the same reproducing time information, i.e., the same time stamp.

FIG. 20 is a view illustrating a providing format of a first signal which is transmitted through an RF broadcast network. Referring to FIG. 20, an SMPTE time code or a frame number, which is pair information, is inserted into a payload area of a separate PES packet, other than a video packet or an audio packet, and is transmitted.

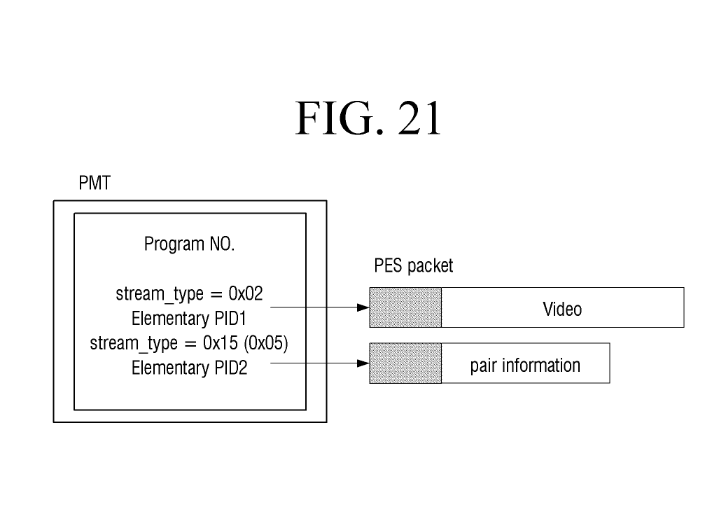

FIG. 21 is a view illustrating a providing format of a TS-based second signal which is transmitted through an IP communication network. Referring to FIG. 21, a PMT designates a stream type, and an SMPTE time code or a frame number, which is pair information, is inserted into a payload area of a separate PES packet, other than a video packet according to the designated stream type, and is transmitted.

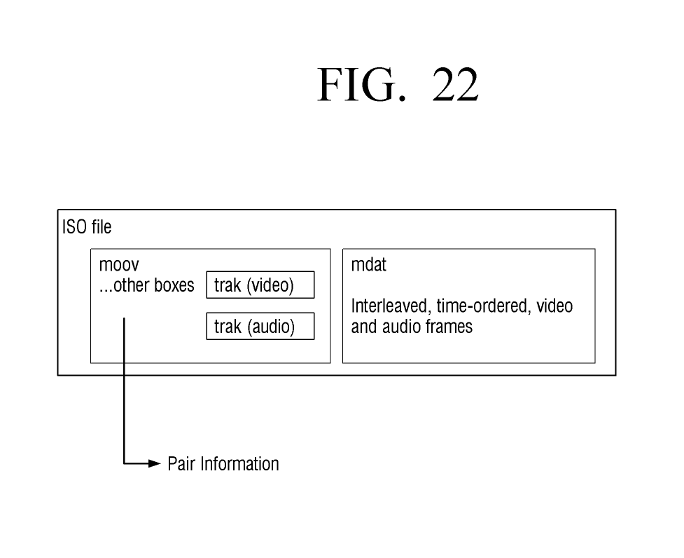

FIG. 22 is a view illustrating a providing format of an MP4-based second signal which is transmitted through an IP communication network. Referring to FIG. 22, a moov header may implicitly provide a value for calculating a frame number using a time-to-sample atom (stts), a composition time to sample atom (ctts), and a sync sample atom (stss), which provide existing frame reproducing time information. In other words, an MP4 file provides a relative time value regarding a reproducing time from a file start location such as a PTS or DTS of a TS through the stts, ctts, and stss. However, since the frame number only provides a relative order of frames, e.g., #1 and #2, the frame number does not have a detailed time unit. Therefore, if the relative time value provided by the stts and ctts is referred, the order of the frames, i.e., the frame number, can be inferred.

Alternatively, the SMPTE time code or the frame number may be explicitly provided by extending a separate box. Specifically, the time code may be provided by defining an additional box in the ISO media base file format (14496-12) or extending a field in an already defined box. For example, the time code may be provided by extending a sync sample table (stss) box which provides random access.

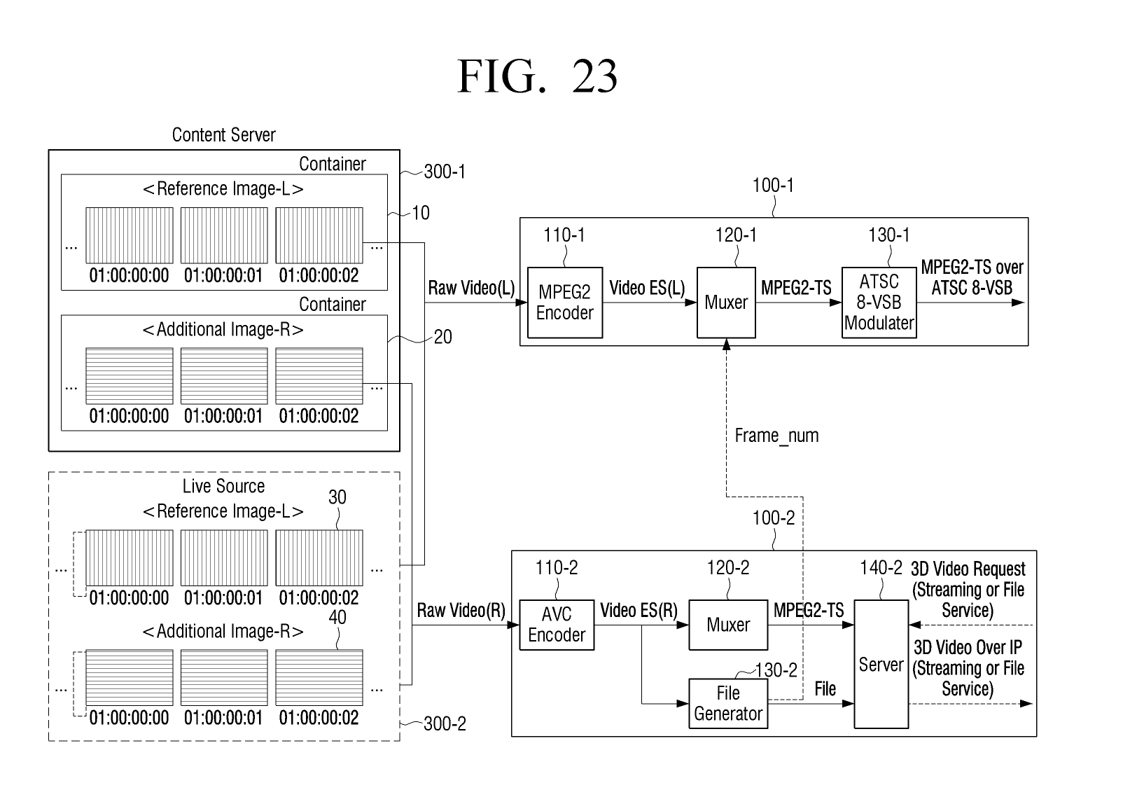

FIG. 23 is a view to explain a configuration of a transmitting system which provides pair information in a PES level and an operation thereof. The transmitting system of FIG. 23 has the same configuration as those of the transmitting systems of FIGS. 11 and 18. Thus, an additional explanation is omitted.

Referring to FIG. 23, a source apparatus 300-1, which is implemented by a content server, and a source apparatus 300-2, which is implemented by a live source, may include an SMPTE time code in a VBI section of raw video data or may include a separate start maker to indicate a start point of a program unit. For example, if pair information is an SMPTE time code, an MPEG2 encoder 110-1 and an AVC encoder 110-2 capture the SMPTE time code which is carried in the VBI section of the raw video data, and include the SMPTE time code in an ES level stream. On the other hand, if pair information is a frame number, a file generator 130-2 recognizes the start marker and transmits a generated frame number to a muxer 120-1 in a transmitting apparatus 1. Accordingly, a frame number value may be included in a first signal.

In FIG. 23 it is determined what generates and inserts PES level pair information according to whether a signal to be transmitted is a transport stream or an MP4 file. If the signal is a transport stream, one of an encoder and a muxer may generate and insert PES level pair information and the encoder may directly generate a separate PES. Also, the muxer may extract a time code or a frame number which is transmitted in an ES level, and may generate pair information of a PES level. On the other hand, if the signal is an MP4 file, the encoder may extract the time code or the frame number which is transmitted in the ES level, and a file generator may insert corresponding information by extending a part of a moov of a file format. As described above, the intermediate process for generating the stream may be combined or configured variously.

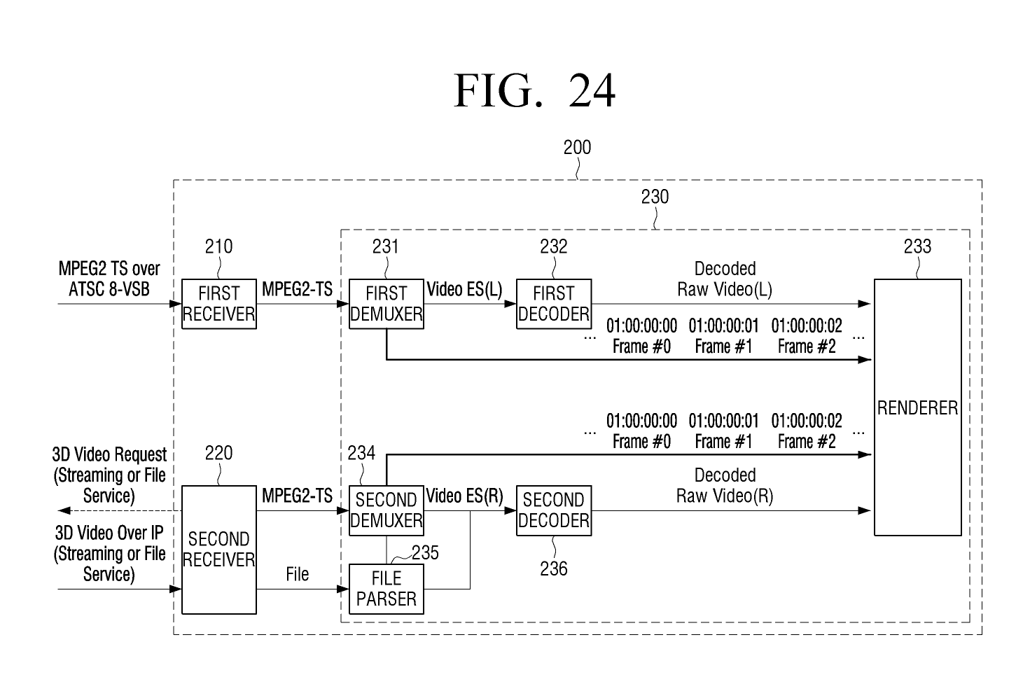

FIG. 24 is a view to explain a configuration and an operation of a receiving apparatus in an exemplary embodiment in which pair information is transmitted in an ES level. Referring to FIG. 24, a receiving apparatus 200 includes first and second receivers 210 and 220 and a signal processor 230. The same elements as those of FIGS. 12 and 19 are not further explained.

A first signal which is received by the first receiver 210 is provided to a first demuxer 231. The first demuxer 231 extracts pair information provided through an ES level, i.e., an SMPTE time code or a frame number, and provides the pair information to a renderer 233. A second signal which is received by the second receiver 220 is provided to a second demuxer 234. The second demuxer 234 also extracts pair information and provides the pair information to the renderer 233. The renderer 233 synchronizes video frames of the first and second signals based on the provided pair information, and outputs the video frames.

As described above, the receiving apparatus 200 determines what pair information is used to perform synchronization, using pair type information. Accordingly, the receiving apparatus 200 performs synchronization in a method that is compatible with an existing broadcast system and is optimized for a configuration thereof.

In FIG. 2, five pieces of pair type information in total are illustrated, but additional pair type information may be added.

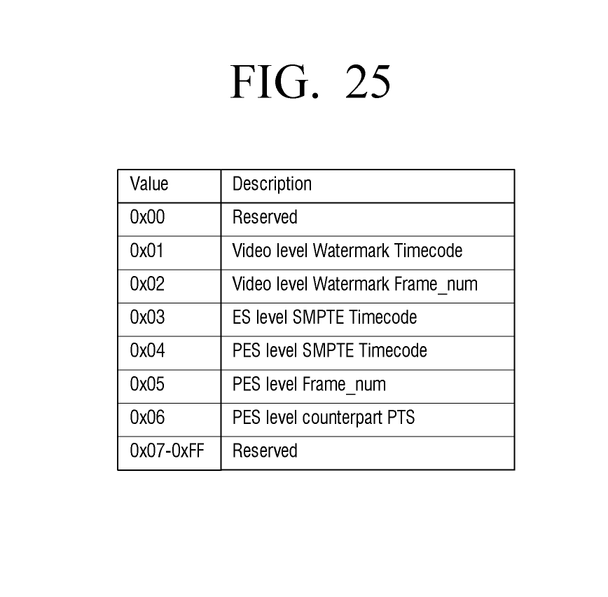

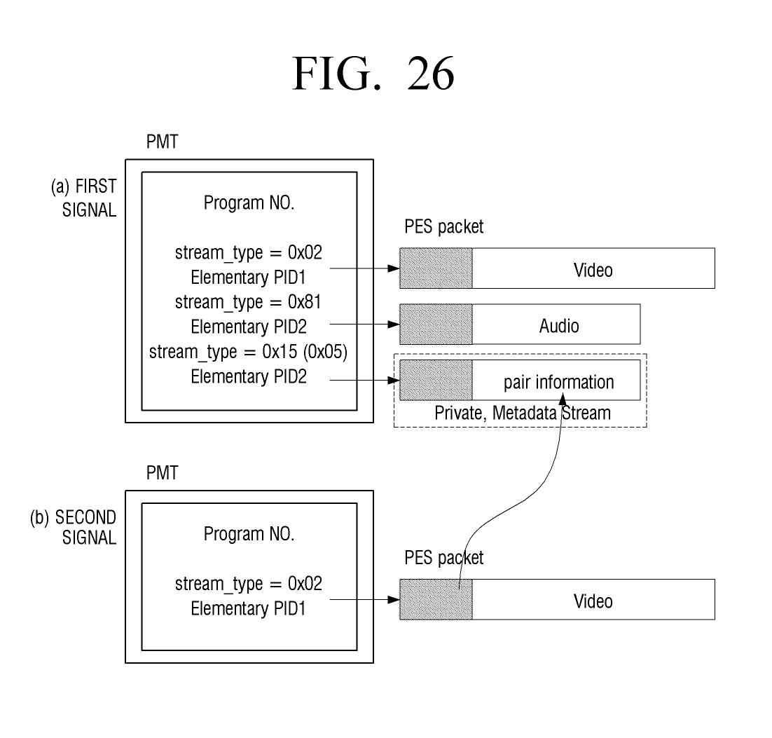

FIG. 25 illustrates pair type information including a value of 0x06. Referring to FIG. 25, pair type information for using a PES level counterpart PTS, as pair information, may be provided. In other words, if pair type information is set to 0x06, the first signal should have a PTS value of the second signal which will be paired with the first signal, and the second signal should have a PTS value of the first signal which will be paired with the second signal. Similar to those of FIGS. 20 and 21, a PTS value may be provided through a private stream corresponding to stream types 0x05 and 0x06, or a metadata stream corresponding to stream types 0x14, 0x15, and 0x16. FIG. 26 illustrates an example of the PTS value.

Referring to FIG. 26, a payload area of a private data stream or a metadata stream which is defined as stream type 0x15 or 0x05 in a PMT of the first signal (a) stores time stamp information of the second signal (b), i.e., the PTS. If time stamp information of a counterpart signal from among signals constituting one content is carried in the first signal, the receiving apparatus 200 identifies the time stamp information, and selects a video frame of the second signal corresponding to a current video frame of the first signal and processes the video frame. As a result, synchronization is achieved.

If time stamp information is used as pair information, the time stamp information may also be recorded in a video level.

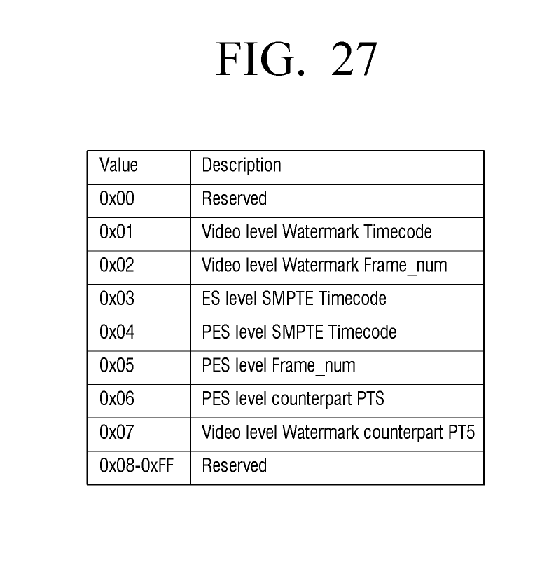

FIG. 27 illustrates pair type information which designates time stamp information of a video level. Referring to FIG. 27, a value of 0x07 is newly defined and a video level watermark counterpart PTS is stored to be matched with the newly defined value.

If pair type information is 0x07, a transmitting system includes a PTS value of a counterpart stream to be synchronized in a video level of each signal in a watermark format.

According to another exemplary embodiment, pair type information and pair information may be provided altogether through a private data stream or a metadata stream.

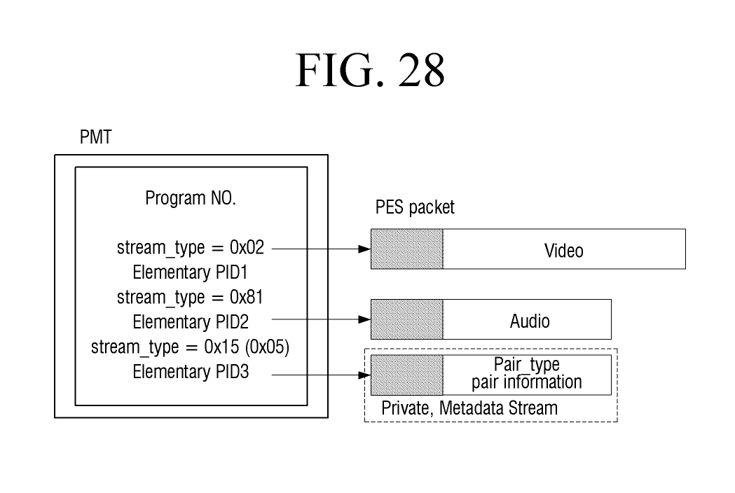

FIG. 28 is a view illustrating pair type information and pair information which are transmitted together through a first signal which is transmitted through an RF broadcast network. Referring to FIG. 28, pair type information (Pair_type) and pair information are included in a payload area of a private data stream or a metadata stream which is defined as stream type 0x15 or 0x05 in a PMT of the first signal.

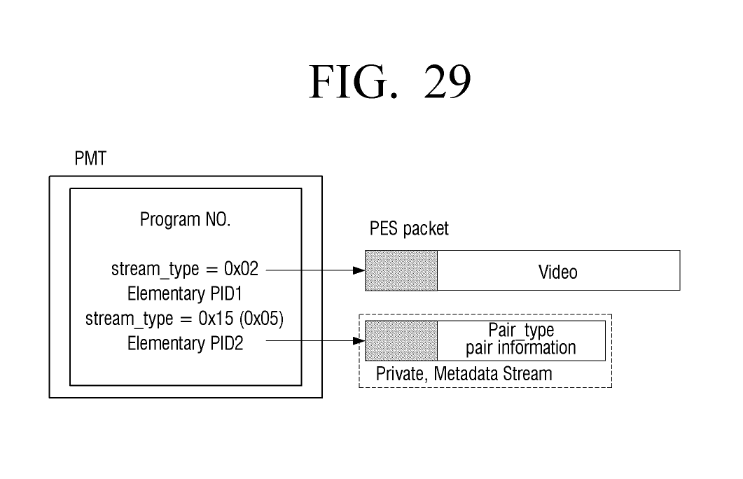

FIG. 29 illustrates pair type information (Pair_type) and pair information which are included in a payload area of a private data stream or a metadata stream in a TS-based second signal which is transmitted through an IP communication network.

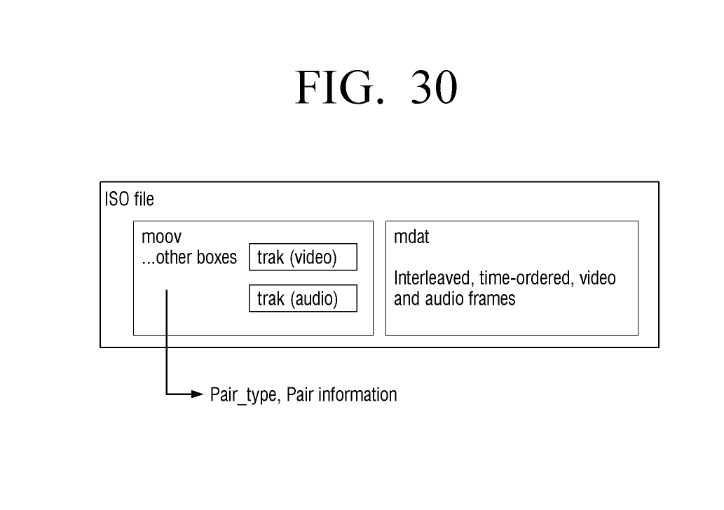

FIG. 30 illustrates pair type information (Pair_type) and pair information which are simultaneously transmitted through a private data stream or a metadata stream of a PES level in an MP4-based second signal, which is transmitted through an IP communication network.

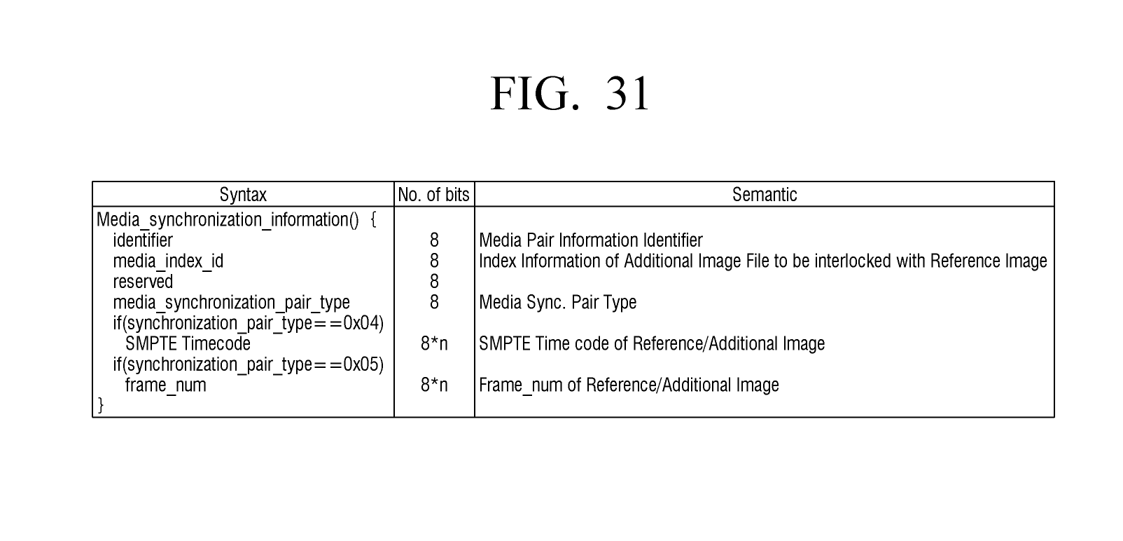

FIG. 31 is a table to explain an example of syntax of pair type information and each portion of the syntax. Referring to FIG. 31, pair type information includes syntax language such as identifier, media_index_id, and media_synchronization_pair_type. Also, an SMPTE time code or a frame number is recorded according to whether media_synchronization_pair_type is 0x04 or 0x05.

As described above, the pair type information is transmitted to the receiving apparatus in various methods, and the receiving apparatus detects necessary pair information based on the pair type information and performs synchronization. Although pair type information is detected from both the first and second signals in the above-described exemplary embodiments, the pair type information may be included in only one of the first and second signals. For example, if pair type information is identified from the first signal, which serve as a reference, the receiving apparatus detects pair information corresponding to the pair type information from the second signal, which is matched with the first signal, and may use the pair information for synchronization.

Also, as described above, the receiving apparatus may be implemented in various forms.

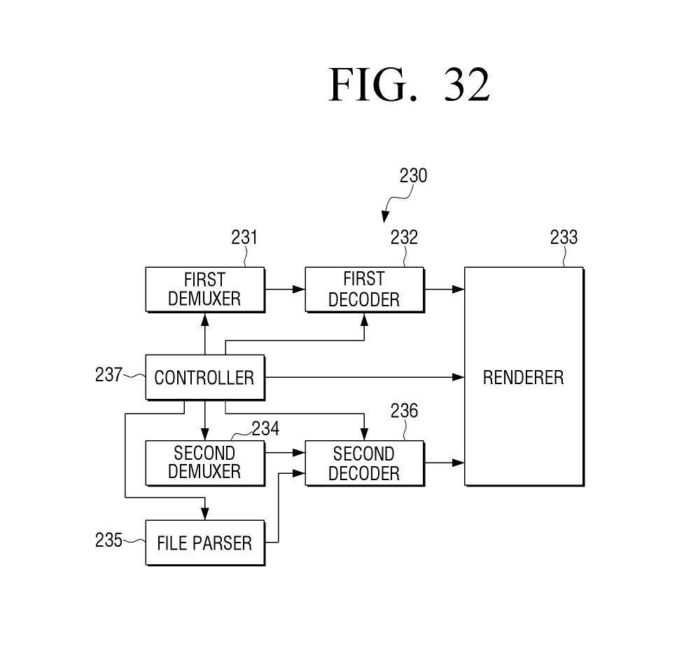

FIG. 32 is a block diagram illustrating another example of a configuration of a signal processor included in a receiving apparatus. Referring to FIG. 32, a signal processor 230 includes a first demuxer 231, a first decoder 232, a renderer 233, a second demuxer 234, a file parser 235, a second decoder 236, and a controller 236.

The first demuxer 231 demuxes a first signal and detects first video data. The second demuxer 234 demuxes a second signal if the second signal has a transport stream format, and detects second video data. On the other hand, if the second signal has a file format, the file parser 235 parses the second signal and detects the second video data. The controller 236 selectively drives the second demuxer 234 or the file parser 235 according to the format of the second signal, and processes the second signal.

The first decoder 232 decodes the first video data which is demuxed by the first demuxer 231, and the second decoder 236 decodes the second video data which is detected by the second demuxer 234 or the file parser 235.

The renderer 233 performs rendering by combining the first video data decoded by the first decoder and the second video data decoded by the second decoder.

The controller 237 controls the elements based on pair type information to synchronize the first and second signals.

In other words, the controller 237 detects pair type information from at least one of the first signal and the second signal. As described above, the pair type information may be transmitted in various formats according to a transmitting method thereof. If each element detects the pair type information during a signal processing operation, the controller 237 receives the pair type information. The controller 237 detects pair information according to the pair type information and controls at least one of the first demuxer 231, the first decoder 232, the renderer 233, the second demuxer 234, the file parser 235, and the second decoder 236 to perform synchronization.

Specifically, if the pair type information designates a time code or a frame number which is recorded in a PES level to be used as pair information, the controller 237 controls the first demuxer 231 and the second demuxer 234 or the first demuxer 231 and the file parser 235 to detect video data which have the same time code or frame number.

Also, if the pair type information designates a time code or a frame number which is recorded in a ES level to be used as pair information, the controller 237 may control the first decoder 232 and the second decoder 236 to decode the first signal and the second signal, and output video data which have the same time code or frame number.

If the pair type information designates a time code or a frame number which is recorded in a video level to be used as pair information, the controller 237 may control the renderer 233 to detect video data having the same time code or frame number from the decoded first signal and the decoded second signal, respectively, and render the video data.

As described above, the signal processor may be configured in various forms and may process the pair type information and the pair information.

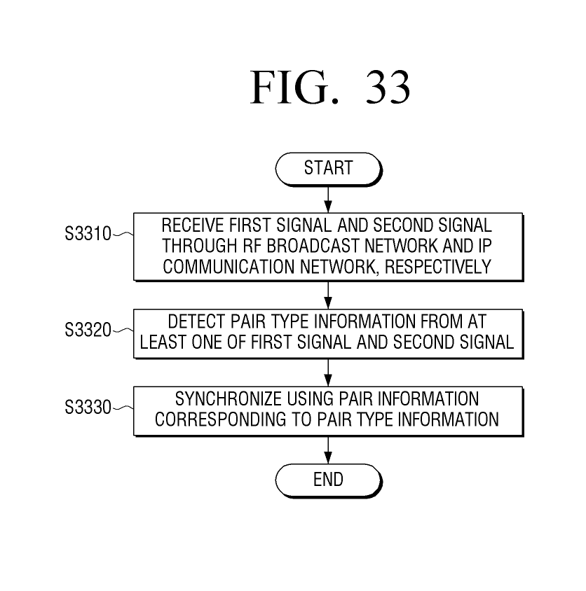

FIG. 33 is a flowchart illustrating a method for processing signals of a receiving apparatus according to various exemplary embodiments. Referring to FIG. 33, the receiving apparatus receives a first signal and a second signal through an RF broadcast network and an IP communication network, respectively (S3310). The first signal and the second signal carry data which is divided from data constituting one content. The first signal and the second signal may be separated based on various criteria according to a type of a content, as described above.

Upon receiving the first signal and the second signal, the receiving apparatus detects pair type information from at least one of the received signals (S3320). As described above in FIG. 2, the pair type information may be set to one of a first value which designates a video level watermark time code as pair information, a second value which designates a video level watermark frame number as pair information, a third value which designates an ES level SMPTE time code as pair information, a fourth value which designates a PES level SMPTE time code as pair information, and a fifth value which designates a PES level frame number as pair information. Also, as shown in FIG. 25 or 27, the pair type information may further include a sixth value which designates a PES level counterpart PTS as pair information, or a seventh value which designates a video level watermark counterpart PTS as pair information.

If the pair type information is identified, the receiving apparatus selects pair information corresponding to the pair type information, from among pair information included in the first signal and the second signal. The receiving apparatus synchronizes the first signal and the second signal with each other according to the selected pair information (S3330). The receiving apparatus may be implemented in various forms as described above. Also, the synchronization may be performed by correcting time stamps to be consistent with each other or selecting a frame based on a time code or a frame number.

As described above, in order to transmit the pair type information with the first signal and the second signal, a transmitting system should perform processing to carry the pair type information. Since this processing could be fully understood based on the above explanations, an illustration thereof is omitted.

The above-described system may be applied to various environments which transmit and receives data having inconsistent time stamps. In other words, the system may be used in various types of hybrid services, which separately transmit contents based on a broadcast network and a network, in addition to 3D contents which include a left-eye image and a right-eye image.

For example, the system may be applied to a data broadcast service system that transmits a 2D broadcast through a broadcast network and transmits data such as multilingual audio data or multilingual subtitle data through a network. Also, the system may be applied to an ultra-high definition (UHD) broadcast service system which transmits a 2D broadcast through a broadcast network and transmits UHD broadcast data through a network. Also, the system may be applied to a multi-view broadcast service system which transmits a 2D broadcast through a broadcast network and transmits data such as depth map data or other view point data through a network, or a multi-angle service system which transmits a 2D broadcast through a broadcast network and provides image data of other photographing angles through a network.

Also, in the above examples, the 2D broadcast is transmitted through only the broadcast network. However, this is merely an example to use an existing broadcast system, and is not limited. In other words, multilingual audio data, multilingual subtitle data, UHD broadcast data, depth map data, and other view point data corresponding to 2D content data may be transmitted through the broadcast network.

In the above examples, the hybrid system using the RF broadcast network and the IP communication network has been explained, but various types of communication networks may be set.

The method for processing the signals of the transmitting apparatus or the method for processing the signals of the receiving apparatus according to various exemplary embodiments described above may be coded as software and may be mounted in various apparatuses.

Specifically, a non-transitory computer readable medium, which stores a program performing: receiving a first signal and a second signal through an RF broadcast network and an IP communication network, respectively; detecting pair type information from at least one of the first signal and the second signal, selecting pair information corresponding to the pair type information from among pair information included in the first signal and the second signal, and synchronizing the first single and the second signal with each other according to the selected pair information, may be installed.

The non-transitory computer readable medium refers to a medium that stores data semi-permanently rather than storing data for a very short time, such as a register, a cache, and a memory, and is readable by an apparatus. Specifically, the above-described various applications or programs may be stored in a non-transitory computer readable medium such as a CD, a DVD, a hard disk, a Blu-ray disk, a USB, a memory card, and a ROM, and may be provided.

The foregoing exemplary embodiments and advantages are merely exemplary and are not to be construed as limiting the present embodiments. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A receiving apparatus comprising:
a first receiver which receives a first signal through a radio frequency (RF) broadcast network;
a second receiver which receives a second signal through an internet protocol (IP) communication network; and
a signal processor which detects pair type information from at least one of the first signal and the second signal, selects pair information, corresponding to the pair type information, from among the pair information included in the at least one of the first signal and the second signal, and synchronizes the first signal and the second signal with each other according to the selected pair information.

2. The receiving apparatus as claimed in claim 1, wherein the signal processor detects the pair type information from a reserved area or a descriptor area in a Program Map Table (PMT) of the at least one of the first signal and the second signal.

3. The receiving apparatus as claimed in claim 1, wherein the signal processor detects the pair type information from a reserved area or a descriptor area of a Program and System Information Protocol Virtual Channel Table (PSIP VCT) or an Event Information Table (EIT) of the at least one of the first signal and the second signal.

4. The receiving apparatus as claimed in claim 1, wherein the signal processor detects the pair type information from a private stream or a metadata stream which is included in the at least one of the first signal and the second signal.

5. The receiving apparatus as claimed in claim 1, wherein the signal processor comprises:
a first demuxer which demuxes the first signal and detects first video data;
a second demuxer which, if the second signal has a transport stream format, demuxes the second signal and detects second video data;
a filer parser which, if the second signal has a file format, parses the second signal and detects the second video data;
a first decoder which decodes the first video data demuxed by the first demuxer;
a second decoder which decodes the second video data detected by the second demuxer or the file parser; and
a renderer which performs rendering by combining the first video data decoded by the first decoder and the second video data decoded by the second decoder,
wherein at least one of the first demuxer, the second demuxer, the file parser, the first decoder, the second decoder, and the renderer is selectively operated according to a value of the pair type information, and detects the pair information.

6. The receiving apparatus as claimed in claim 1, wherein the signal processor comprises:
a first demuxer which demuxes the first signal and detects first video data;
a second demuxer which, if the second signal has a transport stream format, demuxes the second signal and detects the second video data;
a filer parser which, if the second signal has a file format, parses the second signal and detects second video data;
a first decoder which decodes the first video data demuxed by the first demuxer;
a second decoder which decodes the second video data detected by the second demuxer or the file parser;
a renderer which performs rendering by combining the first video data decoded by the first decoder and the second video data decoded by the second decoder; and
a controller which detects the pair type information from the at least one of the first signal and the second signal, and controls at least one of the first demuxer, the second demuxer, the file parser, the first decoder, the second decoder, and the renderer to detect the pair information according to the pair type information, and perform synchronization.

7. The receiving apparatus as claimed in claim 6, wherein, if the pair type information designates a time code or a frame number which is recorded in a Packetized Elementary Stream (PES) level as the pair information, the controller controls the first demuxer and the second demuxer or the first demuxer and the file parser to detect video data which has a same time code or a frame number,
wherein, if the pair type information designates the time code or the frame number which is recorded in an Elementary Stream (ES) level as the pair information, the controller controls the first decoder and the second decoder to decode the first signal and the second signal and then output video data which has a same time code or a frame number,
wherein, if the pair type information designates the time code or the frame number which is recorded in a video level as the pair information, the controller controls the renderer to detect video data which has a same time code or a frame number from the decoded first signal and the decoded second signal, respectively, and render the video data.

8. The receiving apparatus as claimed in claim 1, wherein the pair type information comprises one of a first value which designates a video level watermark time code as the pair information, a second value which designates a video level watermark frame number as the pair information, a third value which designates an Elementary Stream (ES) level Society of Motion Pictures and Television Engineers (SMPTE) time code as the pair information, a fourth value which designates a PES level SMPTE time code as the pair information, a fifth value which designates a PES level frame number as the pair information, a sixth value which designates a PES level counterpart Presentation Time Stamp (PTS) as the pair information, and a seventh value which designates a video level watermark counterpart PTS as the pair information.

9. The receiving apparatus as claimed in claim 1, wherein the first signal comprises one of left-eye image data and right-eye image data of a 3D content, and the second signal comprises the other one of the left-eye image data and the right-eye image data of the 3D content.

10. The receiving apparatus as claimed in claim 1, wherein one of the first signal and the second signal comprises 2D content data,
wherein the other one of the first signal and the second signal comprises at least one of multilingual audio data, multilingual subtitle data, ultra-high definition (UHD) broadcast data, depth map data, and other view point data corresponding to the 2D content data.

11. A method for processing signals of a receiving apparatus, the method comprising:
receiving a first signal and a second signal through a radio frequency (RF) broadcast network and an internet protocol (IP) communication network, respectively;
detecting pair type information from at least one of the first signal and the second signal; and
processing signals by selecting pair information, corresponding to the pair type information, from among the pair information included in the at least one of the first signal and the second signal, and synchronizing the first signal and the second signal with each other according to the selected pair information.

12. The method as claimed in claim 11, wherein the pair type information is recorded on a reserved area or a descriptor area in a Program Map Table (PMT) of the at least one of the first signal and the second signal.

13. The method as claimed in claim 11, wherein the pair type information is recorded on a reserved area or a descriptor area of a Program and System Information Virtual Channel Table (PSIP VCT) or an Event Information Table (EIT) of the at least one of the first signal and the second signal.

14. The method as claimed in claim 11, wherein the pair type information is recorded on a private stream or a metadata stream, which is included in the at least one of the first signal and the second signal.

15. The method as claimed in claim 11, wherein the pair type information comprises one of a first value which designates a video level watermark time code as the pair information, a second value which designates a video level watermark frame number as the pair information, a third value which designates an Elementary Stream (ES) level Society of Motion Picture and Television Engineers (SMPTE) time code as the pair information, a fourth value which designates a PES level SMPTE time code as the pair information, a fifth value which designates a PES level frame number as the pair information, a sixth value which designates a PES level counterpart PTS as the pair information, and a seventh value which designates a video level watermark counterpart Presentation Time Stamp (PTS) as the pair information.

16. A non-transitory computer readable medium storing a program causing a computer to execute a process, the process comprising:
receiving a first signal and a second signal through a radio frequency (RF) broadcast network and an internet protocol (IP) communication network, respectively;
detecting pair type information from at least one of the first signal and the second signal;
selecting pair information, corresponding to the pair type information, from among the pair information included in the at least one of the first signal and the second signal; and
synchronizing the first signal and the second signal with each other according to the selected pair information,
wherein the first signal and the second signal comprise a single multimedia content.
